(19) United States
(12) Patent Application Publication
(10) Pub. No.: US 2024/0163904 A1
(43) Pub. Date: May 16, 2024

(54) METHOD AND APPARATUS FOR SIDELINK RESOURCE SELECTION OR EXCLUSION OF MULTI-CONSECUTIVE TIME TRANSMISSION IN A WIRELESS COMMUNICATION SYSTEM

(71) Applicant: ASUS Technology Licensing Inc., Taipei City (TW)

(72) Inventors: Chun-Wei Huang, Taipei City (TW); Ming-Che Li, Taipei City (TW); Yi-Hsuan Kung, Taipei City (TW); Li-Chih Tseng, Taipei City (TW)

(21) Appl. No.: 18/501,805

(22) Filed: Nov. 3, 2023

Related U.S. Application Data
(60) Provisional application No. 63/422,491, filed on Nov. 4, 2022.
(60) Provisional application No. 63/422,501, filed on Nov. 4, 2022.
(60) Provisional application No. 63/422,820, filed on Nov. 4, 2022.

(51) Int. Cl. H04W 72/25; H04W 72/0446

(52) U.S. Cl. CPC H04W 72/25; H04W 72/0446

(57) ABSTRACT

Methods, systems, and apparatuses are provided for sidelink resource selection or exclusion of multi-consecutive slot transmission (MCSt) in a wireless communication system to enhance and/or modify Legacy sidelink Mode 2 operation for the MCSt. A method of a first device can comprise triggering or requesting sensing-based resource selection or re-selection for performing one or more Physical Sidelink Shared Channel (PSSCH) or Physical Sidelink Control Channel (PSCCH) transmissions in a sidelink resource pool in unlicensed or shared spectrum, determining a first parameter for determining or initializing candidate multi-slot resources, receiving a Sidelink Control Information (SCI) for reserving one or more sidelink resources, selecting a number of sidelink resources from valid/identified/remaining candidate multi-slot resources after exclusion, and performing the one or more PSSCH or PSCCH transmissions on at least one of the selected number of sidelink resources.

### CROSS-REFERENCE TO RELATED APPLICATIONS

The present Application claims priority to and the benefit of U.S. Provisional Patent Application Ser. No. 63/422,491, filed Nov. 4, 2022, U.S. Provisional Patent Application Ser. No. 63/422,501, filed Nov. 4, 2022, and U.S. Provisional Patent Application Ser. No. 63/422,820, filed Nov. 4, 2022; with each referenced disclosure and application fully incorporated herein by reference.

### FIELD

This disclosure generally relates to wireless communication networks and, more particularly, to a method and apparatus for sidelink resource selection or exclusion of multi-consecutive time transmission in a wireless communication system. Multi-consecutive time transmission comprises multi-consecutive TTI transmission, multi-consecutive subframe transmission, multi-consecutive slot transmission, multi-consecutive sub-slot transmission, or multi-consecutive symbol transmission.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for sidelink resource selection or exclusion of multi-consecutive slot transmission (MCSt) in a wireless communication system to enhance and/or modify Legacy sidelink Mode 2 operation for the MCSt.

In various embodiments, a method of a first device can comprise triggering or requesting sensing-based resource selection or re-selection for performing one or more Physical Sidelink Shared Channel (PSSCH) or Physical Sidelink Control Channel (PSCCH) transmissions in a sidelink resource pool in unlicensed or shared spectrum, determining a first parameter for determining or initializing candidate multi-slot resources, receiving a Sidelink Control Information (SCI) for reserving one or more sidelink resources, selecting a number of sidelink resources from valid/identified/remaining candidate multi-slot resources after exclusion, and performing the one or more PSSCH or PSCCH transmissions on at least one of the selected number of sidelink resources.

In various embodiments, a method of a first device comprises triggering or requesting sensing-based resource selection or re-selection for performing one or more PSSCH or PSCCH transmissions in a sidelink resource pool in unlicensed or shared spectrum, determining whether to identify candidate resource comprising sub-channels in more than one Resource Block (RB) set based on at least whether a first number of sub-channels for sidelink data transmission is larger than a threshold, selecting a number of sidelink resources from a set of identified candidate resources, and performing the one or more PSSCH or PSCCH transmissions on at least one of the selected number of sidelink resources.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is an example diagram showing that when sensing-based resource selection is triggered/requested in slot n, (the Physical layer of) the UE will have a (initial) set of candidate single-slot resources comprising multiple candidate single-slot resources, in accordance with embodiments of the present invention.

FIG. 6 is an example table showing blocks can mean sidelink resources are not reserved/scheduled/allocated by other UE(s) or not excluded in exclusion steps/operations, in accordance with embodiments of the present invention.

FIG. 7 is an example diagram showing, assuming there are five common interlaces (e.g., common interlace #0˜#4), interlaces #0˜#4 in RB set 0 corresponds to common interlaces #0˜#4, and interlaces #0˜#4 in RB set 1 corresponds to common interlaces #0˜#4 (i.e., interlace #0 in RB set 1 may not correspond to lowest RB in RB set 1), in accordance with embodiments of the present invention.

FIG. 8 is an example diagram showing, assuming there are five common interlaces (e.g., common interlace #0˜#4), interlaces #0˜#4 in RB set 0 corresponds to common interlaces #0˜#4, and interlaces #0˜#4 in RB set 1 corresponds to common interlaces #0˜#4 (i.e., interlace #0 in RB set 1 may not correspond to lowest RB in RB set 1), in accordance with embodiments of the present invention.

FIG. 9 is an example diagram of a possible combination of RB sets for resource allocation for a sidelink resource pool comprising 3 RB sets, in accordance with embodiments of the present invention.

FIG. 10 is an example diagram showing that association between interlace and sub-channel, in accordance with embodiments of the present invention.

FIG. 11 is an example diagram showing that a UE could be configured with MCSt operation and/or operates/selects resources in a SL resource pool in channel occupancy time in a SL unlicensed spectrum, in accordance with embodiments of the present invention.

FIG. 12 is an example diagram showing, for resource selection for a set of SL resources in a SL resource pool in SL unlicensed spectrum, a UE could select a number of consecutive SL resources, in accordance with embodiments of the present invention.

FIG. 13 is an example diagram showing that a UE could determine or decide to select a set of SL resources for transmission of multiple MAC PDUs, in accordance with embodiments of the present invention.

FIG. 14 is a flow diagram of a method of a first UE comprising receiving a SCI (with a field) indicating a number of contiguous RB sets, and receiving PSSCH based on one or more RB sets, in accordance with embodiments of the present invention.

FIG. 15 is a flow diagram of a method of a first device comprising triggering or requesting sensing-based resource selection or re-selection for performing one or more PSSCH or PSCCH transmission, determining a first parameter for determining or initializing candidate multi-slot resources, receiving a SCI for reserving one or more sidelink resources, selecting a number of sidelink resources, and performing the one or more PSSCH or PSCCH transmissions, in accordance with embodiments of the present invention.

FIG. 16 is a flow diagram of a method of a first device comprising triggering or requesting sensing-based resource selection or re-selection for performing one or more PSSCH or PSCCH transmissions, determining whether to identify candidate resource comprising sub-channels in more than one RB set, selecting a number of sidelink resources from a set of identified candidate resources, and performing the one or more PSSCH or PSCCH transmissions, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TS 38.212 V17.1.0 (2022-03) 3GPP; TSG RAN; NR; Multiplexing and channel coding (Release 17); [2] 3GPP TS 38.214 V17.1.0 (2022-03) 3GPP; TSG RAN; NR; Physical layer procedures for data (Release 17); [3] 3GPP TS 38.212 V17.1.0 (2022-03) 3GPP; TSG RAN; NR; Multiplexing and channel coding (Release 17); [4] 3GPP TS 38.321 v16.7.0 (2021-12) 3GPP; TSG RAN; Medium Access Control (MAC) protocol specification (Release 16); [5] 3GPP TS 37.213 V16.6.0 (2021-06) 3GPP; TSG RAN; Physical layer procedures for shared spectrum channel access (Release 16); [6] 5G New Radio Unlicensed: Challenges and Evaluation, Mohammed Hirzallah, Marwan Krunz, Balkan Kecicioglu and Belal Hamzeh (https://arxiv.org/pdf/2012.10937.pdf); [7] RP-221938, “WID revision: NR sidelink evolution”, OPPO; [8]RAN1 Chair's Notes of 3GPP TSG RAN WG1 #110; and [9] RAN1 Chair's Notes of 3GPP TSG RAN WG1 #110bis-e. The standards and documents listed above are hereby expressly and fully incorporated herein by reference in their entirety.

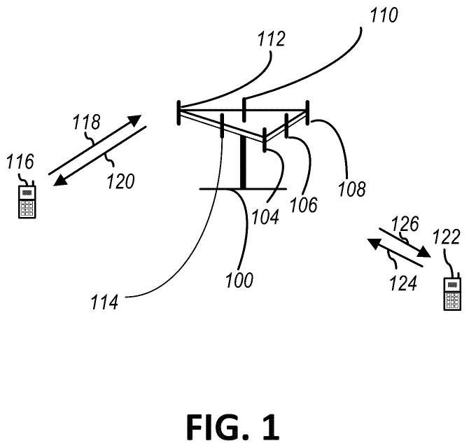

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

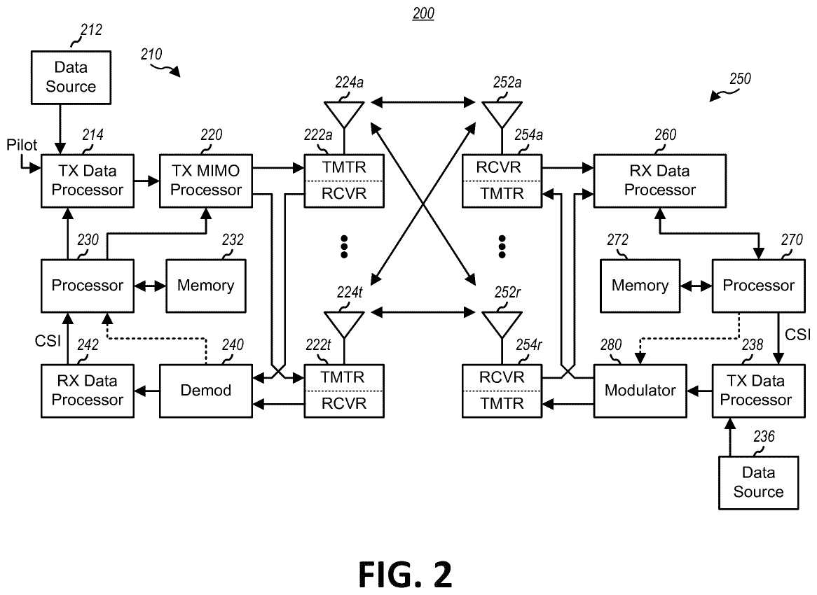

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

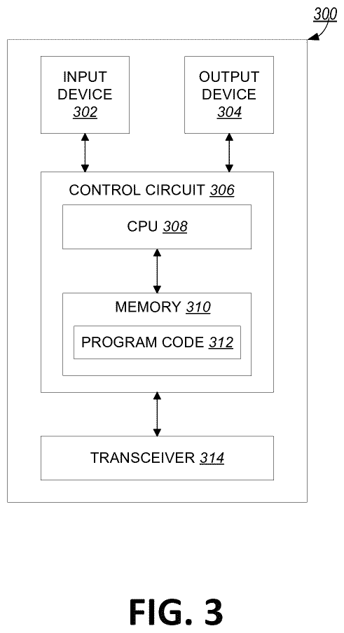

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

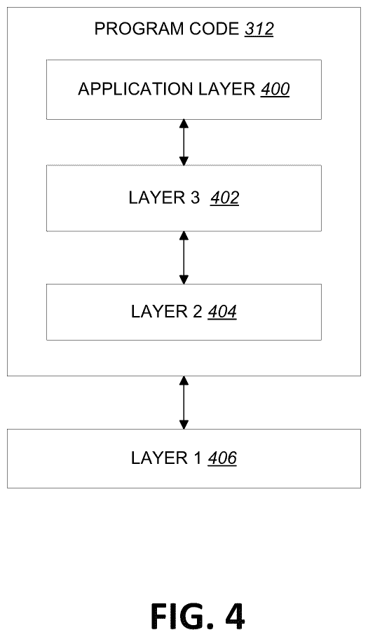

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In TS 38.214 ([2] 3GPP TS 38.214 V17.1.0 (2022-03) 3GPP; TSG RAN; NR; Physical layer procedures for data (Release 17)), SL related procedures for data are specified.

### ******************************* Quotation [2] Start *********************************

### 8 Physical Sidelink Shared Channel Related Procedures

A UE can be configured by higher layers with one or more sidelink resource pools. A sidelink resource pool can be for transmission of PSSCH, as described in Clause 8.1, or for reception of PSSCH, as described in Clause 8.3 and can be associated with either sidelink resource allocation mode 1 or sidelink resource allocation mode 2.

In the frequency domain, a sidelink resource pool consists of sl-NumSubchannel contiguous sub-channels. A sub-channel consists of sl-SubchannelSize contiguous PRBs, where sl-NumSubchannel and sl-SubchannelSize are higher layer parameters.

The set of slots that may belong to a sidelink resource pool is denoted by (t₀^{SL}, t₁^{SL}, . . . , t_{Tmax-1}^{SL}) where . . .

The UE determines the set of resource blocks assigned to a sidelink resource pool as follows:
The resource block pool consists of N_{PRB} PRBs.
The sub-channel m for m=0, 1, . . . , numSubchannel−1 consists of a set of n_{subCHsize} contiguous resource blocks with the physical resource block number n_{PRB}=n_{subCHRBstart}+m·n_{subCHsize}+j for j=0, 1, . . . , n_{subCHsize}−1, where n_{subCHRBstart} and n_{subCHsize} are given by higher layer parameters sl-StartRB-Subchannel and sl-SubchannelSize, respectively

. . .

### 8.1 UE Procedure for Transmitting the Physical Sidelink Shared Channel

Each PSSCH transmission is associated with an PSCCH transmission.

That PSCCH transmission carries the 1^{st} stage of the SCI associated with the PSSCH transmission; the 2^{nd} stage of the associated SCI is carried within the resource of the PSSCH.

If the UE transmits SCI format 1-A on PSCCH according to a PSCCH resource configuration in slot n and PSCCH resource m, then for the associated PSSCH transmission in the same slot

. . .

### 8.1.2.1 Resource Allocation in Time Domain

The UE shall transmit the PSSCH in the same slot as the associated PSCCH.

The minimum resource allocation unit in the time domain is a slot.

. . .

### 8.1.2.2 Resource Allocation in Frequency Domain

The resource allocation unit in the frequency domain is the sub-channel.

The sub-channel assignment for sidelink transmission is determined using the “Frequency resource assignment” field in the associated SCI.

The lowest sub-channel for sidelink transmission is the sub-channel on which the lowest PRB of the associated PSCCH is transmitted.

If a PSSCH scheduled by a PSCCH would overlap with resources containing the PSCCH, the resources corresponding to a union of the PSCCH that scheduled the PSSCH and associated PSCCH DM-RS are not available for the PSSCH.

. . .

### 8.1.4 UE Procedure for Determining the Subset of Resources to be Reported to Higher Layers in PSSCH Resource Selection in Sidelink Resource Allocation Mode 2

In resource allocation mode 2, the higher layer can request the UE to determine a subset of resources from which the higher layer will select resources for PSSCH/PSCCH transmission. To trigger this procedure, in slot n, the higher layer provides the following parameters for this PSSCH/PSCCH transmission:
the resource pool from which the resources are to be reported;
L1 priority, prio_{TX};
the remaining packet delay budget;
the number of sub-channels to be used for the PSSCH/PSCCH transmission in a slot, L_{subCH};
optionally, the resource reservation interval, P_{rsvp_TX}, in units of msec.
. . .

The following higher layer parameters affect this procedure:
sl-SelectionWindowList: internal parameter T₂ₘᵢₙ is set to the corresponding value from higher layer parameter sl-SelectionWindowList for the given value of Prio_{TX}.
sl-Thres-RSRP-List: this higher layer parameter provides an RSRP threshold for each combination (pᵢ, pⱼ), where pᵢ is the value of the priority field in a received SCI format 1-A and pⱼ is the priority of the transmission of the UE selecting resources; for a given invocation of this procedure, pⱼ=Prio_{TX}.
sl-RS-ForSensing selects if the UE uses the PSSCH-RSRP or PSCCH-RSRP measurement, as defined in clause 8.4.2.1.
sl-ResourceReservePeriodList
sl-Sensing Window: internal parameter T₀ is defined as the number of slots corresponding to sl-Sensing Window msec
sl-TxPercentageList: internal parameter X for a given prio_{TX} is defined as sl-TxPercentageList (prio_{TX}) converted from percentage to ratio
. . .

The resource reservation interval, P_{rsvp_TX}, if provided, is converted from units of msec to units of logical slots, resulting in P_{rsvp_TX}′ according to clause 8.1.7.

When the resource pool is (pre-)configured with allowedResourceSelectionConfig including full sensing, and full sensing is (pre-)configured in the UE by higher layers, the UE performs full sensing.

. . .

### Notation:

(t₀^{SL}, t₁^{SL}, t₂^{SL}, . . . ) denotes the set of slots which belongs to the sidelink resource pool and is defined in Clause 8.

The following steps are used:
1) A candidate single-slot resource for transmission R_{x,y} is defined as a set of L_{subCH} contiguous sub-channels with sub channel x+j in slot t′_{y}^{SL} where j=0, . . . . L_{subCH}−1. The UE shall assume that any set of L_{subCH} contiguous sub-channels included in the corresponding resource pool within the time interval [n+T₁, n+T₂] correspond to one candidate single-slot resource for UE performing full sensing, in a set of Y candidate slots within the time interval [n+T₁, n+T₂] for UE performing periodic-based partial sensing correspond to one candidate single-slot resource, or in a set of Y′ candidate slots within the time interval [n+T₁, n+T₂] for UE performing contiguous partial sensing if P_{rsvp_TX}=0, correspond to one candidate single-slot resource, where
   selection of T₁ is up to UE implementation under 0≤T₁≤T_{proc,1}^{SL}, where T_{proc,1}^{SL} is defined in slots in Table 8.1.4-2 where μ_{SL} is the SCS configuration of the SL BWP;
   if T₂ₘᵢₙ is shorter than the remaining packet delay budget (in slots) then T₂ is up to UE implementation subject to T₂ₘᵢₙ≤T₂≤remaining packet delay budget (in slots); otherwise T₂ is set to the remaining packet delay budget (in slots).
   Y is selected by UE where Y≥Yₘᵢₙ.
   . . .

The total number of candidate single-slot resources is denoted by Mₜₒₜₐₗ.
2) The sensing window is defined by the range of slots [n−T₀, n−T_{proc,0}^{SL}), when the UE performs full sensing, where T₀ is defined above and T_{proc,0}^{SL} is defined in slots in Table 8.1.4-1 where μ_{SL} is the SCS configuration of the SL BWP. The UE shall monitor slots which belongs to a sidelink resource pool within the sensing window except for those in which its own transmissions occur. The UE shall perform the behaviour in the following steps based on PSCCH decoded and RSRP measured in these slots.

. . .

Whether the UE is required to performs SL reception of PSCCH and RSRP measurement for partial sensing on slots in SL DRX inactive time is enabled/disabled by higher layer parameter partialSensingInactiveTime. When it is enabled, if UE performs periodic-based partial sensing on the slots in SL DRX inactive time for a given periodicity corresponding to Pᵣₑₛₑᵣᵥₑ, UE monitors only the default periodic sensing occasions (most recent sensing occasion) from the slots; if UE performs contiguous partial sensing on the slots in SL DRX inactive time, UE monitors a minimum of M slots from the slots.
3) The internal parameter Th(pᵢ,pⱼ) is set to the corresponding value of RSRP threshold indicated by the i-th field in sl-Thres-RSRP-List, where i=pᵢ+(pⱼ−1)*8.
4) The set S_{A} is initialized to the set of all the candidate single-slot resources.
5) The UE shall exclude any candidate single-slot resource R_{xy} from the set S_{A} if it meets all the following conditions:
   the UE has not monitored slot t′ₘ^{SL} in Step 2.
   for any periodicity value allowed by the higher layer parameter sl-ResourceReservePeriodList and a hypothetical SCI format 1-A received in slot t′ₘ^{SL} with ‘Resource reservation period’ field set to that periodicity value and indicating all subchannels of the resource pool in this slot, condition c in step 6 would be met.
5a) If the number of candidate single-slot resources R_{x,y} remaining in the set S_{A} is smaller than X·Mₜₒₜₐₗ, the set S_{A} is initialized to the set of all the candidate single-slot resources as in step 4.
6) The UE shall exclude any candidate single-slot resource R_{x,y} from the set S_{A} if it meets all the following conditions:
   a) the UE receives an SCI format 1-A in slot t′ₘ^{SL}, and ‘Resource reservation period’ field, if present, and ‘Priority’ field in the received SCI format 1-A indicate the values P_{rsvp_RX} and prio_{RX}, respectively according to Clause 16.4 in [6, TS 38.213];
b) the RSRP measurement performed, according to clause 8.4.2.1 for the received SCI format 1-A, is higher than Th(prio_{RX}, prio_{TX});
c) the SCI format received in slot t′ₘ^{SL} or the same SCI format which, if and only if the ‘Resource reservation period’ field is present in the received SCI format 1-A, is assumed to be received in slot(s)

$${t}_{m + q \times {P}_{rsvp \_ RX}^{′}}^{′ SL}$$

determines according to clause 8.1.5 the set of resource blocks and slots which overlaps with

$${R}_{x , y + j \times {P}_{rsvp \_ TX}^{′}}$$

for q=1, 2, . . . , Q and j=0, 1, . . . , Cᵣₑₛₑₜ−1. Here, P_{rsvp_RX}′ is P_{rsvp_RX} converted to units of logical slots according to clause 8.1.7,

$$Q = ⌈ \frac{{T}_{scal}}{{P}_{rsvp \_ RX}} ⌉$$

if P_{rsvp_RX}<T_{scal} and n′−m≤P_{rsvp_RX}′, where if the UE is configured with full sensing by its higher layer, t′_{n′}^{SL}=n if slot n belongs to the set (t′₀^{SL}, t′₁^{SL}, . . . , t′_{T′}_{ₘₐₓ}₋₁^{SL}), otherwise slot t′_{n′}^{SL} is the first slot after slot n belonging to the set (t′₀^{SL}, t′₁^{SL}, . . . , t′_{T′}_{ₘₐₓ}₋₁^{SL}); If UE is configured with partial sensing by its higher layer, t′_{n′}^{SL}=t′_{y}_{ᵢ}^{SL}−T_{proc,1}^{SL} if slot t′_{yi}^{SL}−T_{proc,1}^{SL} belongs to the set (t′₀^{SL}, t′₁^{SL}, . . . , t′_{T′}_{ₘₐₓ}₋₁^{SL}), otherwise, slot t′_{n′}^{SL} is the first slot after slot t′_{y}_{ᵢ}^{SL}−T_{proc,1}^{SL} belonging to the set (t′₀^{SL}, t′₁^{SL}, . . . , t′_{T′}_{ₘₐₓ}₋₁^{SL}). Otherwise Q=1. If the UE is configured with full sensing by its higher layer, T_{scal} is set to selection window size T₂ converted to units of msec. If UE is configured with partial sensing by its higher layer, T_{scal}=t′_{y}_{_{L}}^{SL}−(t′_{y}_{ᵢ}^{SL}−T_{proc,1}^{SL}) shall be converted to milliseconds, where slot t′_{y}_{_{L}}^{SL} is the last slot of the Y or Y′ candidate slots. The slot t′_{y}_{ᵢ}^{SL} is the first slot of the selected/remaining set of Y or Y′ candidate slots.
6a) This step is executed only if the procedure in clause 8.1.4A is triggered.
6b) This step is executed only if the procedure in clause 8.1.4C is triggered.
7) If the number of candidate single-slot resources remaining in the set S_{A} is smaller than X·Mₜₒₜₐₗ, then Th(pᵢ,pⱼ) is increased by 3 dB for each priority value Th(pᵢ,pⱼ) and the procedure continues with step 4.
7a) If sidelink DRX active time of RX UE is provided by the higher layer and there is no candidate single-slot resource remained within the sidelink DRX active time in the set S_{A}, the UE based on its implementation additionally selects and includes at least one candidate single-slot resources within the sidelink DRX active time in the set S_{A}.

The UE shall report set S A to higher layers.

. . .

8.1.5 UE Procedure for Determining Slots and Resource Blocks for PSSCH Transmission Associated with an SCI Format 1-A

The set of slots and resource blocks for PSSCH transmission is determined by the resource used for the PSCCH transmission containing the associated SCI format 1-A, and fields ‘Frequency resource assignment’, ‘Time resource assignment’ of the associated SCI format 1-A as described below.

‘Time resource assignment’ carries logical slot offset indication of N=1 or 2 actual resources when sl-MaxNumPerReserve is 2, and N=1 or 2 or 3 actual resources when sl-MaxNumPerReserve is 3, in a form of time RIV (TRIV) field which is determined as follows:

. . .

where the first resource is in the slot where SCI format 1-A was received, and tᵢ denotes i-th resource time offset in logical slots of a resource pool with respect to the first resource where for N=2, 1≤t₁≤31; and for N=3, 1≤t₁≤30, t₁<t₂≤31.

The starting sub-channel n_{subCH,0}^{start} of the first resource is determined according to clause 8.1.2.2. The number of contiguously allocated sub-channels for each of the N resources L_{subCH}≥1 and the starting sub-channel indexes of resources indicated by the received SCI format 1-A, except the resource in the slot where SCI format 1-A was received, are determined from “Frequency resource assignment” which is equal to a frequency RIV (FRIV) where.

If sl-MaxNumPerReserve is 2 then

FRIV=n_{subCH,1}^{start}+Σᵢ₌₁^{L}^{_{subCH}}⁻¹(N_{subchannel}^{SL}+1−i)

If sl-MaxNumPerReserve is 3 then

FRIV=n_{subCH,1}^{start}+n_{subCH,2}^{start}·(N_{subchannel}^{SL}+1−L_{subCH})+Σᵢ₌₁^{L}^{_{subCH}}⁻¹(N_{subchannel}^{SL}+1−i)²

where
n_{subCH,1}^{start} denotes the starting sub-channel index for the second resource
n_{subCH,2}^{start} denotes the starting sub-channel index for the third resource
N_{subchannel}^{SL} is the number of sub-channels in a resource pool provided according to the higher layer parameter sl-NumSubchannel

If TRIV indicates N<sl-MaxNumPerReserve, the starting sub-channel indexes corresponding to sl-MaxNumPerReserve minus N last resources are not used.

. . .

### 8.3 UE Procedure for Receiving the Physical Sidelink Shared Channel

For sidelink resource allocation mode 1, a UE upon detection of SCI format 1-A on PSCCH can decode PSSCH according to the detected SCI formats 2-A and 2-B, and associated PSSCH resource configuration configured by higher layers. The UE is not required to decode more than one PSCCH at each PSCCH resource candidate.

For sidelink resource allocation mode 2, a UE upon detection of SCI format 1-A on PSCCH can decode PSSCH according to the detected SCI formats 2-A and 2-B, and associated PSSCH resource configuration configured by higher layers. The UE is not required to decode more than one PSCCH at each PSCCH resource candidate.

### ******************************* Quotation [2] End *********************************

In TS 38.212 ([3] 3GPP TS 38.212 V17.1.0 (2022-03) 3GPP; TSG RAN; NR; Multiplexing and channel coding (Release 17)), SCI format for sidelink is specified.

### ******************************* Quotation [3] Start *********************************

### 8.3 Sidelink Control Information on PSCCH

SCI carried on PSCCH is a 1^{st}-stage SCI, which transports sidelink scheduling information.

8.3.1 1^{st}-Stage SCI Formats

. . .

### 8.3.1.1 SCI Format 1-A

SCI format 1-A is used for the scheduling of PSSCH and 2^{nd}-stage-SCI on PSSCH

The following information is transmitted by means of the SCI format 1-A:
Priority—3 bits as specified in clause 5.4.3.3 of [12, TS 23.287] and clause 5.22.1.3.1 of [8, TS 38.321]. Value ‘000’ of Priority field corresponds to priority value ‘1’, value ‘001’ of Priority field corresponds to priority value ‘2’, and so on.
Frequency resource assignment— . . .
Time resource assignment—5 bits when the value of the higher layer parameter sl-MaxNumPerReserve is configured to 2; otherwise 9 bits when the value of the higher layer parameter sl-MaxNumPerReserve is configured to 3, as defined in clause 8.1.5 of [6, TS 38.214].
Resource reservation period—└log₂ N_{rsv_period}┘ bits as defined in clause 16.4 of [5, TS 38.213], where N_{rsv_period} is the number of entries in the higher layer parameter sl-ResourceReservePeriodList, if higher layer parameter sl-MultiReserveResource is configured; 0 bit otherwise.
DMRS pattern—└log₂ Nₚₐₜₜₑᵣₙ┘ bits as defined in clause 8.4.1.1.2 of [4, TS 38.211], where Nₚₐₜₜₑᵣₙ is the number of DMRS patterns configured by higher layer parameter sl-PSSCH-DMRS-TimePatternList.
2^{nd}-stage SCI format—2 bits as defined in Table 8.3.1.1-1.
   . . .

TABLE 8.3.1.1-1
2^{nd}-stage SCI formats

| Value of 2nd-stage SCI | |
|---|---|
| format field | 2nd-stage SCI format |
| 00 | SCI format 2-A |
| 01 | SCI format 2-B |
| 10 | SCI format 2-C |
| 11 | Reserved |

### 8.4 Sidelink Control Information on PSSCH

SCI carried on PSSCH is a 2^{nd}-stage SCI, which transports sidelink scheduling information, and/or inter-UE coordination related information.

8.4.1 2^{nd}-Stage SCI Formats

. . .

### 8.4.1.1 SCI Format 2-A

SCI format 2-A is used for the decoding of PSSCH, with HARQ operation when HARQ-ACK information includes ACK or NACK, when HARQ-ACK information includes only NACK, or when there is no feedback of HARQ-ACK information.

The following information is transmitted by means of the SCI format 2-A:
HARQ process number—4 bits.
New data indicator—1 bit.
Redundancy version—2 bits as defined in Table 7.3.1.1.1-2.
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Cast type indicator—2 bits as defined in Table 8.4.1.1-1 and in clause 8.1 of [6, TS 38.214].
CSI request—1 bit as defined in clause 8.2.1 of [6, TS 38.214] and in clause 8.1 of [6, TS 38.214].

TABLE 8.4.1.1-1
Cast type indicator

| Value of Cast type | |
|---|---|
| indicator | Cast type |
| 00 | Broadcast |
| 01 | Groupcast |
| | when HARQ-ACK information includes |
| | ACK or NACK |
| 10 | Unicast |
| 11 | Groupcast |
| | when HARQ-ACK information includes |
| | only NACK |

### 8.4.1.2 SCI Format 2-B

SCI format 2-B is used for the decoding of PSSCH, with HARQ operation when HARQ-ACK information includes only NACK, or when there is no feedback of HARQ-ACK information.

The following information is transmitted by means of the SCI format 2-B:
HARQ process number—4 bits.
New data indicator—1 bit.
Redundancy version—2 bits as defined in Table 7.3.1.1.1-2.
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Zone ID—12 bits as defined in clause 5.8.11 of [9, TS 38.331].
Communication range requirement—4 bits determined by higher layer parameter sl-ZoneConfigMCR-Index.

### 8.4.1.3 SCI Format 2-C

SCI format 2-C is used for the decoding of PSSCH, and providing inter-UE coordination information or requesting inter-UE coordination information.

The following information is transmitted by means of the SCI format 2-C:
HARQ process number—4 bits
New data indicator—1 bit
Redundancy version—2 bits as defined in Table 7.3.1.1.1-2
Source ID—8 bits as defined in clause 8.1 of [6, TS 38.214]
Destination ID—16 bits as defined in clause 8.1 of [6, TS 38.214]
HARQ feedback enabled/disabled indicator—1 bit as defined in clause 16.3 of [5, TS 38.213]
CSI request—1 bit as defined in clause 8.2.1 of [6, TS 38.214] and in clause 8.1 of [6, TS 38.214]
Providing/Requesting indicator—1 bit, where value 0 indicates SCI format 2-C is used for providing inter-UE coordination information and value 1 indicates SCI format 2-C is used for requesting inter-UE coordination information

. . .

8.4.5 Multiplexing of Coded 2^{nd}-Stage SCI Bits to PSSCH

The coded 2^{nd}-stage SCI bits are multiplexed onto PSSCH according to the procedures in Clause 8.2.1.

### ******************************* Quotation [3] End *********************************

In [4] 3GPP TS 38.321 v16.7.0 (2021-12) 3GPP; TSG RAN; Medium Access Control (MAC) protocol specification (Release 16), LBT related operation and SL operation is quoted below:

### ******************************* Quotation [4] Start *********************************

### 5.21 LBT Operation

### 5.21.1 General

The lower layer may perform an LBT procedure, see TS 37.213 [18], according to which a transmission is not performed by lower layers if the channel is identified as being occupied. When lower layer performs an LBT procedure before a transmission and the transmission is not performed, an LBT failure indication is sent to the MAC entity from lower layers. Unless otherwise specified, when LBT procedure is performed for a transmission, actions as specified in this specification are performed regardless of if an LBT failure indication is received from lower layers. When LBT is not performed by the lower layers, LBT failure indication is not received from lower layers.

### 5.22 SL-SCH Data Transfer

### 5.22.1 SL-SCH Data Transmission

### 5.22.1.1 SL Grant Reception and SCI Transmission

. . .

If the MAC entity has been configured with Sidelink resource allocation mode 2 to transmit using pool(s) of resources in a carrier as indicated in TS 38.331 [5] or TS 36.331 based on full sensing, or partial sensing, or random selection or any combination(s), the MAC entity shall for each Sidelink process:
NOTE 1: If the MAC entity is configured with Sidelink resource allocation mode 2 to transmit using a pool of resources in a carrier as indicated in TS 38.331 [5] or TS 36.331 [21], the MAC entity can create a selected sidelink grant on the pool of resources based on random selection, or partial sensing, or full sensing only after releasing configured sidelink grant(s), if any.
1> if the MAC entity has selected to create a selected sidelink grant corresponding to transmissions of multiple MAC PDUs, and SL data is available in a logical channel:
   2> . . . 2> if the TX resource (re-)selection is triggered as the result of the TX resource (re-)selection check:
      3> if one or multiple SL DRX is configured in the destination UE(s) receiving SL-SCH data:
         4> indicate to the physical layer SL DRX active time in the destination UE(s) receiving SL-SCH data, as specified in clause 5.28.2.
      3> select one of the allowed values configured by RRC in sl-ResourceReservePeriodList and set the resource reservation interval, P_{rsvp_TX}, with the selected value;
      3> randomly select, with equal probability, an integer value in the interval [5, 15] for the resource reservation interval higher than or equal to 100 ms or in the interval

$$[ 5 \times ⌈ \frac{100}{max ( 20 , {P}_{rsvp \_ TX} )} ⌉ , 15 \times ⌈ \frac{100}{max ( 20 , {P}_{rsvp \_ TX} )} ⌉ ]$$

for the resource reservation interval lower than 100 ms and set SL_RESOURCE_RESELECTION_COUNTER to the selected value;
3> select the number of HARQ retransmissions from the allowed numbers, if configured by RRC, in sl-MaxTxTransNumPSSCH included in sl-PSSCH-TxConfigList and, if configured by RRC, overlapped in sl-MaxTxTransNumPSSCH indicated in sl-CBR-PriorityTxConfigList for the highest priority of the logical channel(s) allowed on the carrier and the CBR measured by lower layers according to clause 5.1.27 of TS 38.215 if CBR measurement results are available or the corresponding sl-defaultTxConfiglndex configured by RRC if CBR measurement results are not available;
3> select an amount of frequency resources within the range, if configured by RRC, between sl-MinSubChannelNumPSSCH and sl-MaxSubchannelNumPSSCH included in sl-PSSCH-TxConfigList and, if configured by RRC, overlapped between MinSubChannelNumPSSCH and MaxSubchannelNumPSSCH indicated in sl-CBR-PriorityTxConfigList for the highest priority of the logical channel(s) allowed on the carrier and the CBR measured by lower layers according to clause 5.1.27 of TS 38.215 if CBR measurement results are available or the corresponding sl-defaultTxConfiglndex configured by RRC if CBR measurement results are not available;
3> if not configured by RRC, interUECoordinationScheme1Explicit or interUECoordinationScheme1Condition enabling reception of preferred resource set and non-preferred resource set:
   4> if transmission based on random selection is configured by upper layers:
   5> randomly select the time and frequency resources for one transmission opportunity from the resource pool which occur within the SL DRX active time as specified in clause 5.28.2 of the destination UE selected for indicating to the physical layer the SL DRX active time above, according to the amount of selected frequency resources and the remaining PDB of SL data available in the logical channel(s) allowed on the carrier.
   5> if selected resource for initial transmission occasion is not in the SL DRX Active time as specified in clause 5.28.1 of any destination that has data to be sent:
   6> use retransmission occasion(s) for initial transmission of PSCCH and PSSCH.
   4> else:
   5> randomly select the time and frequency resources for one transmission opportunity from the resources indicated by the physical layer as specified in clause 8.1.4 of TS 38.214 [7] which occur within the SL DRX active time as specified in clause 5.28.2 of the destination UE selected for indicating to the physical layer the SL DRX active time above, according to the amount of selected frequency resources and the remaining PDB of SL data available in the logical channel(s) allowed on the carrier.
3> . . . r
3> if one or more HARQ retransmissions are selected:
   4> if not configured by RRC, interUECoordinationScheme1Explicit or interUECoordinationScheme1Condition enabling reception of preferred resource set and non-preferred resource set:
   5> if transmission based on full sensing or partial sensing is configured by upper layers and there are available resources left in the resources indicated by the physical layer according to clause 8.1.4 of TS 38.214 [7] for more transmission opportunities; or
   5> if transmission based on random selection is configured by upper layers and there are available resources left in the resource pool for more transmission opportunities:
   6> randomly select the time and frequency resources for one or more transmission opportunities from the available resources which occur within the SL DRX active time as specified in clause 5.28.2 of the destination UE selected for indicating to the physical layer the SL DRX active time above, according to the amount of selected frequency resources, the selected number of HARQ retransmissions and the remaining PDB of SL data available in the logical channel(s) allowed on the carrier by ensuring the minimum time gap between any two selected resources in case that PSFCH is configured for this pool of resources and that a retransmission resource can be indicated by the time resource assignment of a prior SCI according to clause 8.3.1.1 of TS 38.212 [9].
   4> . . . .
   4> use the randomly selected resource to select a set of periodic resources spaced by the resource reservation interval for transmissions of PSCCH and PSSCH corresponding to the number of retransmission opportunities of the MAC PDUs determined in TS 38.214 [7];
   4> consider the first set of transmission opportunities as the initial transmission opportunities and the other set(s) of transmission opportunities as the retransmission opportunities;
   4> consider the sets of initial transmission opportunities and retransmission opportunities as the selected sidelink grant.
3> else:
   4> consider the set as the selected sidelink grant.
3> use the selected sidelink grant to determine the set of PSCCH durations and the set of PSSCH durations according to TS 38.214 [7].
2> . . .
1> if the MAC entity has selected to create a selected sidelink grant corresponding to transmission(s) of a single MAC PDU, and if SL data is available in a logical channel, or an SL-CSI reporting is triggered:
   2> . . .
   2> else if SL data is available in the logical channel:
      3> if sl-HARQ-FeedbackEnabled is set to enabled for the logical channel:
         4> select any pool of resources configured with PSFCH resources among the pools of resources except the pool(s) in sl-BWP-DiscPoolConfig or sl-BWP-DiscPoolConfigCommon, if configured.
      3> else:
         4> select any pool of resources among the pools of resources except the pool(s) in sl-BWP-DiscPoolConfig or sl-BWP-DiscPoolConfigCommon, if configured.
   2> perform the TX resource (re-)selection check on the selected pool of resources as specified in clause 5.22.1.2;
   2> if the TX resource (re-)selection is triggered as the result of the TX resource (re-)selection check:
      3> if one or multiple SL DRX is configured in the destination UE(s) receiving SL-SCH data:
         4> indicate to the physical layer SL DRX active time in the destination UE(s) receiving SL-SCH data, as specified in clause 5.28.2.
      3> select the number of HARQ retransmissions from the allowed numbers, if configured by RRC, in sl-MaxTxTransNumPSSCH included in sl-PSSCH-TxConfigList and, if configured by RRC, overlapped in sl-MaxTxTransNumPSSCH indicated in sl-CBR-PriorityTxConfigList for the highest priority of the logical channel(s) allowed on the carrier and the CBR measured by lower layers according to clause 5.1.27 of TS 38.215 if CBR measurement results are available or the corresponding sl-defaultTxConfiglndex configured by RRC if CBR measurement results are not available;
      3> select an amount of frequency resources within the range, if configured by RRC, between sl-MinSubChannelNumPSSCH and sl-MaxSubChannelNumPSSCH included in sl-PSSCH-TxConfigList and, if configured by RRC, overlapped between sl-MinSubChannelNumPSSCH and sl-MaxSubChannelNumPSSCH indicated in sl-CBR-PriorityTxConfigList for the highest priority of the logical channel(s) allowed on the carrier and the CBR measured by lower layers according to clause 5.1.27 of TS 38.215 if CBR measurement results are available or the corresponding sl-defaultTxConfiglndex configured by RRC if CBR measurement results are not available;
      3> if not configured by RRC, interUECoordinationScheme1Explicit or interUECoordinationScheme1Condition enabling reception of preferred resource set and non-preferred resource set:
         4> if transmission based on random selection is configured by upper layers:
         5> randomly select the time and frequency resources for one transmission opportunity from the resources pool which occur within the SL DRX active time as specified in clause 5.28.2 of the destination UE selected for indicating to the physical layer the SL DRX active time above, according to the amount of selected frequency resources and the remaining PDB of SL data available in the logical channel(s) allowed on the carrier, and the latency requirement of the triggered SL CSI reporting.
         4> else:
         5> randomly select the time and frequency resources for one transmission opportunity from the resources indicated by the physical layer as specified in clause 8.1.4 of TS 38.214 [7] which occur within the SL DRX active time as specified in clause 5.28.2 of the destination UE selected for indicating to the physical layer the SL DRX active time above, according to the amount of selected frequency resources and the remaining PDB of SL data available in the logical channel(s) allowed on the carrier, and/or the latency requirement of the triggered SL-CSI reporting.
      3> . . .
      3> if one or more HARQ retransmissions are selected:
         4> if not configured by RRC, interUECoordinationScheme1Explicit or interUECoordinationScheme1Condition enabling reception of preferred resource set and non-preferred resource set:
         5> if transmission based on sensing or partial sensing is configured by upper layers and there are available resources left in the resources indicated by the physical layer according to clause 8.1.4 of TS 38.214 [7] for more transmission opportunities; or
         5> if transmission based on random selection is configured by upper layers and there are available resources left in the resources pool for more transmission opportunities:
         6> randomly select the time and frequency resources for one or more transmission opportunities from the available resources which occur within the SL DRX active time as specified in clause 5.28.2 of the destination UE selected for indicating to the physical layer the SL DRX active time above, according to the amount of selected frequency resources, the selected number of HARQ retransmissions and the remaining PDB of SL data available in the logical channel(s) allowed on the carrier, and/or the latency requirement of the triggered SL-CSI by ensuring the minimum time gap between any two selected resources in case that PSFCH is configured for this pool of resources, and that a retransmission resource can be indicated by the time resource assignment of a prior SCI according to clause 8.3.1.1 of TS 38.212 [9];
         6> consider a transmission opportunity which comes first in time as the initial transmission opportunity and other transmission opportunities as the retransmission opportunities;
         6> consider all the transmission opportunities as the selected sidelink grant.
         4> . . .
         4> use the randomly selected resource to select a set of periodic resources spaced by the resource reservation interval for transmissions of PSCCH and PSSCH corresponding to the number of retransmission opportunities of the MAC PDUs determined in TS 38.214 [7];
         4> consider the first set of transmission opportunities as the initial transmission opportunities and the other set(s) of transmission opportunities as the retransmission opportunities;
         4> consider the sets of initial transmission opportunities and retransmission opportunities as the selected sidelink grant.
      3> else:
         4> consider the set as the selected sidelink grant.
      3> use the selected sidelink grant to determine PSCCH duration(s) and PSSCH duration(s) according to TS 38.214 [7].

. . .

### 5.22.1.3 Sidelink HARQ Operation

### 5.22.1.3.1 Sidelink HARQ Entity

The MAC entity includes at most one Sidelink HARQ entity for transmission on SL-SCH, which maintains a number of parallel Sidelink processes.

The maximum number of transmitting Sidelink processes associated with the Sidelink HARQ Entity is 16. A sidelink process may be configured for transmissions of multiple MAC PDUs. For transmissions of multiple MAC PDUs with Sidelink resource allocation mode 2, the maximum number of transmitting Sidelink processes associated with the Sidelink HARQ Entity is 4.

A delivered sidelink grant and its associated Sidelink transmission information are associated with a Sidelink process. Each Sidelink process supports one TB.

For each sidelink grant, the Sidelink HARQ Entity shall:
1> if the MAC entity determines that the sidelink grant is used for initial transmission as specified in clause 5.22.1.1; or
1> if the sidelink grant is a configured sidelink grant and no MAC PDU has been obtained in an sl-PeriodCG of the configured sidelink grant; or
1> if the sidelink grant is a dynamic sidelink grant or selected sidelink grant and no MAC PDU has been obtained in the previous sidelink grant when PSCCH duration(s) and 2n d stage SCI on PSSCH of the previous sidelink grant is not in SL DRX Active time as specified in clause 5.28.1 of the destination that has data to be sent:
NOTE 1: Void.
   2> (re-)associate a Sidelink process to this grant, and for the associated Sidelink process:
   2> if all PSCCH duration(s) and PSSCH duration(s) for initial transmission of a MAC PDU of the dynamic sidelink grant or the configured sidelink grant is not in SL DRX Active time as specified in clause 5.28.1 of the destination that has data to be sent:
      3> ignore the sidelink grant.
   NOTE 1A: The Sidelink HARQ Entity will associate the selected sidelink grant to the Sidelink process determined by the MAC entity.
      3> obtain the MAC PDU to transmit from the Multiplexing and assembly entity, if any;
      3> if a MAC PDU to transmit has been obtained:
         4> if a HARQ Process ID has been set for the sidelink grant:
         5> (re-)associate the HARQ Process ID corresponding to the sidelink grant to the Sidelink process.
         4> determines Sidelink transmission information of the TB for the source and destination pair of the MAC PDU as follows:
         5> set the Source Layer-1 ID to the 8 LSB of the Source Layer-2 ID of the MAC PDU;
         5> set the Destination Layer-1 ID to the 16 LSB of the Destination Layer-2 ID of the MAC PDU;
         5> (re-)associate the Sidelink process to a Sidelink process ID;
         NOTE 1b: How UE determine Sidelink process ID in SCI is left to UE implementation for NR sidelink
         5> consider the NDI to have been toggled compared to the value of the previous transmission corresponding to the Sidelink identification information and the Sidelink process ID of the MAC PDU and set the NDI to the toggled value;
         5> set the cast type indicator to one of broadcast, groupcast and unicast as indicated by upper layers;
         5> . . .
         4> deliver the MAC PDU, the sidelink grant and the Sidelink transmission information of the TB to the associated Sidelink process;
         4> instruct the associated Sidelink process to trigger a new transmission.
      3> else:
         4> flush the HARQ buffer of the associated Sidelink process.

. . .

### 5.22.1.3.1a Sidelink Process

The Sidelink process is associated with a HARQ buffer.

New transmissions and retransmissions are performed on the resource indicated in the sidelink grant as specified in clause 5.22.1.1 and with the MCS selected as specified in clause 8.1.3.1 of TS 38.214 [7] and clause 5.22.1.1.

If the Sidelink process is configured to perform transmissions of multiple MAC PDUs with Sidelink resource allocation mode 2, the process maintains a counter SL_RESOURCE_RESELECTION_COUNTER. For other configurations of the Sidelink process, this counter is not available.

### 5.22.1.4 Multiplexing and Assembly

For PDU(s) associated with one SCI, MAC shall consider only logical channels with the same Source Layer-2 ID-Destination Layer-2 ID pair for one of unicast, groupcast and broadcast which is associated with the pair. Multiple transmissions for different Sidelink processes are allowed to be independently performed in different PSSCH durations.

### 5.22.1.4.1 Logical Channel Prioritization

### 5.22.1.4.1.1 General

The sidelink Logical Channel Prioritization procedure is applied whenever a new transmission is performed.

RRC controls the scheduling of sidelink data by signalling for each logical channel:
sl-Priority where an increasing priority value indicates a lower priority level;
sl-PrioritisedBitRate which sets the sidelink Prioritized Bit Rate (sPBR);
sl-BucketSizeDuration which sets the sidelink Bucket Size Duration (sBSD).

. . .

The following UE variable is used for the Logical channel prioritization procedure:
SBj which is maintained for each logical channel j.

The MAC entity shall initialize SBj of the logical channel to zero when the logical channel is established.

For each logical channel j, the MAC entity shall:
1> increment SBj by the product sPBR×T before every instance of the LCP procedure, where T is the time elapsed since SBj was last incremented;
1> if the value of SBj is greater than the sidelink bucket size (i.e. sPBR×sBSD):
   2> set SBj to the sidelink bucket size.

### 5.22.1.4.1.2 Selection of Logical Channels

The MAC entity shall for each SCI corresponding to a new transmission:
1> if sl-BWP-DiscPoolConfig or sl-BWP-DiscPoolConfigCommon is configured according to TS 38.331 [5]:
   2> if the new transmission is associated with a sidelink grant in sl-DiscTxPoolSelected or sl-DiscTxPoolScheduling configured in sl-BWP-DiscPoolConfig or sl-BWP-DiscPoolConfigCommon:
      3>
   2> else:
      3> select a Destination associated with one of unicast, groupcast and broadcast (excluding the Destination(s) associated with sidelink discovery as specified in TS 23.304 [26]), having at least one of the MAC CE and the logical channel with the highest priority, among the logical channels that satisfy all the following conditions and MAC CE(s), if any, for the SL grant associated to the SCI:
         4> SL data is available for transmission; and
         4> SBj>0, in case there is any logical channel having SBj>0; and
         4> sl-configuredGrantType1Allowed, if configured, is set to true in case the SL grant is a Configured Grant Type 1; and
         4> sl-AllowedCG-List, if configured, includes the configured grant index associated to the SL grant; and
         4> sl-HARQ-FeedbackEnabled is set to disabled, if PSFCH is not configured for the SL grant associated to the SCI.
1> else:
   2> select a Destination associated to one of unicast, groupcast and broadcast, that is in the SL active time for the SL transmission occasion if SL DRX is applied for the destination, and having at least one of the MAC CE and the logical channel with the highest priority, among the logical channels that satisfy all the following conditions and MAC CE(s), if any, for the SL grant associated to the SCI:
      3> SL data is available for transmission; and
      3> SBj>0, in case there is any logical channel having SBj>0; and
      3> sl-configuredGrantType1Allowed, if configured, is set to true in case the SL grant is a Configured Grant Type 1; and
         3> sl-AllowedCG-List, if configured, includes the configured grant index associated to the SL grant; and
         3> sl-HARQ-FeedbackEnabled is set to disabled, if PSFCH is not configured for the SL grant associated to the SCI.
1> select the logical channels satisfying all the following conditions among the logical channels belonging to the selected Destination:
   2> SL data is available for transmission; and
   2> . . .

### 5.22.1.4.1.3 Allocation of Sidelink Resources

The MAC entity shall for each SCI corresponding to a new transmission:
1> allocate resources to the logical channels as follows:
   2> logical channels selected in clause 5.22.1.4.1.2 for the SL grant with SBj>0 are allocated resources in a decreasing priority order. If the sPBR of a logical channel is set to infinity, the MAC entity shall allocate resources for all the data that is available for transmission on the logical channel before meeting the sPBR of the lower priority logical channel(s);
   2> decrement SBj by the total size of MAC SDUs served to logical channel j above;
   2> if any resources remain, all the logical channels selected in clause 5.22.1.4.1.2 are served in a strict decreasing priority order (regardless of the value of SBj) until either the data for that logical channel or the SL grant is exhausted, whichever comes first. Logical channels configured with equal priority should be served equally.
NOTE: The value of SBj can be negative.

. . .

### 5.22.1.4.2 Multiplexing of MAC Control Elements and MAC SDUs

The MAC entity shall multiplex a MAC CE and MAC SDUs in a MAC PDU according to clauses 5.22.1.4.1 and 6.1.6.

. . .

### 5.22.2 SL-SCH Data Reception

### 5.22.2.1 SCI Reception

SCI indicates if there is a transmission on SL-SCH and provide the relevant HARQ information. An SCI consists of two parts: the 1^{st} stage SCI on PSCCH and the 2^{nd} stage SCI on PSSCH as specified in clause 8.1 of TS 38.214 [7].

The MAC entity shall:
1> for each PSCCH duration during which the MAC entity monitors PSCCH:
   2> if a Pt stage SCI has been received on the PSCCH:
      3> determine the set of PSSCH durations in which reception of a 2^{nd} stage SCI and the transport block occur using the received part of the SCI;
      3> if the 2^{nd} stage SCI for this PSSCH duration has been received on the PSSCH:
         4> store the SCI as a valid SCI for the PSSCH durations corresponding to transmission(s) of the transport block and the associated HARQ information and QoS information;
1> for each PSSCH duration for which the MAC entity has a valid SCI:
   2> deliver the SCI and the associated Sidelink transmission information to the Sidelink HARQ Entity.

### 5.22.2.2 Sidelink HARQ Operation

### 5.22.2.2.1 Sidelink HARQ Entity

There is at most one Sidelink HARQ Entity at the MAC entity for reception of the SL-SCH, which maintains a number of parallel Sidelink processes.

Each Sidelink process is associated with SCI in which the MAC entity is interested. This interest is determined by the Sidelink identification information of the SCI. The Sidelink HARQ Entity directs Sidelink transmission information and associated TBs received on the SL-SCH to the corresponding Sidelink processes.

### ******************************* Quotation [4] End *********************************

In [5] 3GPP TS 37.213 V16.6.0 (2021-06) 3GPP; TSG RAN; Physical layer procedures for shared spectrum channel access (Release 16), channel procedures for unlicensed spectrum are quoted below.

### ******************************* Quotation [5] Start *********************************

### 4 Channel Access Procedure

### 4.0 General

Unless otherwise noted, the definitions below are applicable for the following terminologies used in this specification:
A channel refers to a carrier or a part of a carrier consisting of a contiguous set of resource blocks (RBs) on which a channel access procedure is performed in shared spectrum.
A channel access procedure is a procedure based on sensing that evaluates the availability of a channel for performing transmissions. The basic unit for sensing is a sensing slot with a duration Tₛₗ=9 us. The sensing slot duration Tₛₗ is considered to be idle if an eNB/gNB or a UE senses the channel during the sensing slot duration, and determines that the detected power for at least 4 us within the sensing slot duration is less than energy detection threshold X_{Thresh}. Otherwise, the sensing slot duration Tₛₗ is considered to be busy.
A channel occupancy refers to transmission(s) on channel(s) by eNB/gNB/UE(s) after performing the corresponding channel access procedures in this clause.
A Channel Occupancy Time refers to the total time for which eNB/gNB/UE and any eNB/gNB/UE(s) sharing the channel occupancy perform transmission(s) on a channel after an eNB/gNB/UE performs the corresponding channel access procedures described in this clause. For determining a Channel Occupancy Time, if a transmission gap is less than or equal to 25 us, the gap duration is counted in the channel occupancy time. A channel occupancy time can be shared for transmission between an eNB/gNB and the corresponding UE(s).
A DL transmission burst is defined as a set of transmissions from an eNB/gNB without any gaps greater than 16 us. Transmissions from an eNB/gNB separated by a gap of more than 16 us are considered as separate DL transmission bursts. An eNB/gNB can transmit transmission(s) after a gap within a DL transmission burst without sensing the corresponding channel(s) for availability.
A UL transmission burst is defined as a set of transmissions from a UE without any gaps greater than 16 us. Transmissions from a UE separated by a gap of more than 16 us are considered as separate UL transmission bursts. A UE can transmit transmission(s) after a gap within a UL transmission burst without sensing the corresponding channel(s) for availability.

### 4.1.1 Type 1 DL Channel Access Procedures

This clause describes channel access procedures to be performed by an eNB/gNB where the time duration spanned by the sensing slots that are sensed to be idle before a downlink transmission(s) is random. The clause is applicable to the following transmissions:
Transmission(s) initiated by an eNB including PDSCH/PDCCH/EPDCCH, or
Any transmission(s) initiated by a gNB.

The eNB/gNB may transmit a transmission after first sensing the channel to be idle during the sensing slot durations of a defer duration T_{d} and after the counter N is zero in step 4. The counter N is adjusted by sensing the channel for additional sensing slot duration(s) according to the steps below:
1) set N=Nᵢₙᵢₜ, where Nᵢₙᵢₜ is a random number uniformly distributed between 0 and CWₚ, and go to step 4;
2) if N>0 and the eNB/gNB chooses to decrement the counter, set N=N−1;
3) sense the channel for an additional sensing slot duration, and if the additional sensing slot duration is idle, go to step 4; else, go to step 5;
4) if N=0, stop; else, go to step 2.
5) sense the channel until either a busy sensing slot is detected within an additional defer duration T_{d} or all the sensing slots of the additional defer duration T_{d} are detected to be idle;
6) if the channel is sensed to be idle during all the sensing slot durations of the additional defer duration T_{d}, go to step 4; else, go to step 5;

The defer duration T_{d} consists of duration T_{f}=16 us immediately followed by mₚ consecutive sensing slot durations Tₛₗ, and T_{f} includes an idle sensing slot duration Tₛₗ at start of T_{f}.

If an eNB/gNB transmits discovery burst(s) as described in clause 4.1.2 when N>0 in the procedure above, the eNB/gNB shall not decrement N during the sensing slot duration(s) overlapping with discovery burst(s).

TABLE 4.1.1-1
Channel Access Priority Class (CAPC)

| Channel | | | | | |
|---|---|---|---|---|---|
| Access | | | | | |
| Priority | | | | | allowed |
| Class (p) | mₚ | CW_{min, p} | CW_{max, p} | T_{m cot, p} | CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, |
| | | | | | 127, 255, |
| | | | | | 511, 1023} |

### 4.1.2 Type 2 DL Channel Access Procedures

This clause describes channel access procedures to be performed by an eNB/gNB where the time duration spanned by sensing slots that are sensed to be idle before a downlink transmission(s) is deterministic.

Type 2A channel access procedures as described in clause 4.1.2.1 are only applicable to the following transmission(s) performed by an eNB/gNB:
Transmission(s) by an eNB/gNB following transmission(s) by a UE after a gap of 25 us in a shared channel occupancy as described in clause 4.1.3.

Type 2B or Type 2C DL channel access procedures as described in clause 4.1.2.2 and 4.1.2.3, respectively, are applicable to the transmission(s) performed by a gNB following transmission(s) by a UE after a gap of 16 us or up to 16 us, respectively, in a shared channel occupancy as described in clause 4.1.3.

### 4.1.2.1 Type 2A DL Channel Access Procedures

An eNB/gNB may transmit a DL transmission immediately after sensing the channel to be idle for at least a sensing interval T_{short_dl}=25 us. T_{short_dl} consists of a duration T_{f}=16 us immediately followed by one sensing slot and T_{f} includes a sensing slot at start of T_{f}. The channel is considered to be idle for T_{short_dl} if both sensing slots of T_{short_dl} are sensed to be idle.

### 4.1.2.2 Type 2B DL Channel Access Procedures

A gNB may transmit a DL transmission immediately after sensing the channel to be idle within a duration of T_{f}=16 us. T_{f} includes a sensing slot that occurs within the last 9 us of T_{f}. The channel is considered to be idle within the duration T_{f} if the channel is sensed to be idle for a total of at least 5 us with at least 4 us of sensing occurring in the sensing slot.

### 4.1.2.3 Type 2C DL Channel Access Procedures

When a gNB follows the procedures in this clause for transmission of a DL transmission, the gNB does not sense the channel before transmission of the DL transmission. The duration of the corresponding DL transmission is at most 584 us.

### 4.1.3 DL Channel Access Procedures in a Shared Channel Occupancy

. . .

If a gNB shares a channel occupancy initiated by a UE using the channel access procedures described in clause 4.2.1.1 on a channel, the gNB may transmit a transmission that follows a UL transmission on scheduled resources or a PUSCH transmission on configured resources by the UE after a gap as follows:
The transmission shall contain transmission to the UE that initiated the channel occupancy and can include non-unicast and/or unicast transmissions where any unicast transmission that includes user plane data is only transmitted to the UE that initiated the channel occupancy.
   If the higher layer parameters ul-toDL-COT-SharingED-Threshold-r16 is not provided, the transmission shall not include any unicast transmissions with user plane data and the transmission duration is not more than the duration of 2, 4 and 8 symbols for subcarrier spacing of 15, 30 and 60 kHz of the corresponding channel, respectively.
If the gap is up to 16 us, the gNB can transmit the transmission on the channel after performing Type 2C DL channel access as described in clause 4.1.2.3.
If the gap is 25 us or 16 us, the gNB can transmit the transmission on the channel after performing Type 2A or Type 2B DL channel access procedures as described in clause 4.1.2.1 and 4.1.2.2, respectively.

For the case where a gNB shares a channel occupancy initiated by a UE with configured grant PUSCH transmission, the gNB may transmit a transmission that follows the configured grant PUSCH transmission by the UE as follows:
If the higher layer parameter ul-toDL-COT-SharingED-Threshold-r16 is provided, the UE is configured by cg-COT-SharingList-r16 where cg-COT-SharingList-r16 provides a table configured by higher layer. Each row of the table provides a channel occupancy sharing information given by higher layer parameter CG-COT-Sharing-r16. One row of the table is configured for indicating that the channel occupancy sharing is not available.
   If the ‘COT sharing information’ in CG-UCI detected in slot n indicates a row index that corresponds to a CG-COT-Sharing-r16 that provides channel occupancy sharing information, the gNB can share the UE channel occupancy assuming a channel access priority class p=channelAccessPriority-r16, starting from slot n+0, where O=offset-r16 slots, for a duration of D=duration-r16 slots where duration-r16, offset-r16, and channelAccessPriority-r16 are higher layer parameters provided by CG-COT-Sharing-r16.
If the higher layer parameter ul-toDL-COT-SharingED-Threshold-r16 is not provided, and if ‘COT sharing information’ in CG-UCI indicates ‘1’, the gNB can share the UE channel occupancy and start the DL transmission X=cg-COT-SharingOffset-r16 symbols from the end of the slot where CG-UCI is detected, where cg-COT-SharingOffset-r16 is provided by higher layer. The transmission shall not include any unicast transmissions with user plane data and the transmission duration is not more than the duration of 2, 4 and 8 symbols for subcarrier spacing of 15, 30 and 60 kHz of the corresponding channel, respectively.

For the case where a gNB uses channel access procedures as described in clause 4.1.1 to initiate a transmission and shares the corresponding channel occupancy with a UE that transmits a transmission as described in clause 4.2.1.2, the gNB may transmit a transmission within its channel occupancy that follows the UE's transmission if any gap between any two transmissions in the gNB channel occupancy is at most 25 us. In this case the following applies:
If the gap is 25 us or 16 us, the gNB can transmit the transmission on the channel after performing Type 2A or 2B DL channel access procedures as described in clause 4.1.2.1 and 4.1.2.2, respectively.
If the gap is up to 16 us, the gNB can transmit the transmission on the channel after performing Type 2C DL channel access as described in clause 4.1.2.3.

### 4.2 Uplink Channel Access Procedures

A UE performing transmission(s) on LAA Scell(s), an eNB scheduling or configuring UL transmission(s) for a UE performing transmission(s) on LAA Scell(s), and a UE performing transmission(s) on channel(s) and a gNB scheduling or configuring UL transmission(s) for a UE performing transmissions on channel(s) shall perform the procedures described in this clause for the UE to access the channel(s) on which the transmission(s) are performed.

In this clause, transmissions from a UE are considered as separate UL transmissions, irrespective of having a gap between transmissions or not, and X_{Thresh} for sensing is adjusted as described in clause 4.2.3 when applicable.

### 4.2.1 Channel Access Procedures for Uplink Transmission(s)

A UE can access a channel on which UL transmission(s) are performed according to one of Type 1 or Type 2 UL channel access procedures. Type 1 channel access procedure is described in clause 4.2.1.1. Type 2 channel access procedure is described in clause 4.2.1.2.

If a UL grant scheduling a PUSCH transmission indicates Type 1 channel access procedures, the UE shall use Type 1 channel access procedures for transmitting transmissions including the PUSCH transmission unless stated otherwise in this clause.

A UE shall use Type 1 channel access procedures for transmitting transmissions including the autonomous or configured grant PUSCH transmission on configured UL resources unless stated otherwise in this clause.

If a UL grant scheduling a PUSCH transmission indicates Type 2 channel access procedures, the UE shall use Type 2 channel access procedures for transmitting transmissions including the PUSCH transmission unless stated otherwise in this clause.

If a UE is scheduled by a gNB to transmit PUSCH and one or more SRSs by a single UL grant in non-contiguous transmissions, or a UE is scheduled by a gNB to transmit PUCCH and/or SRSs by a single DL assignment in non-contiguous transmissions, the UE shall use the channel access procedure indicated by the scheduling DCI for the first UL transmission scheduled by the scheduling DCI. If the channel is sensed by the UE to be continuously idle after the UE has stopped transmitting the first transmission, the UE may transmit further UL transmissions scheduled by the scheduling DCI using Type 2 channel access procedures or Type 2A UL channel access procedures without applying a CP extension if the further UL transmissions are within the gNB Channel Occupancy Time. Otherwise, if the channel sensed by the UE is not continuously idle after the UE has stopped transmitting the first UL transmission or the further UL transmissions are outside the gNB Channel Occupancy Time, the UE may transmit the further UL transmissions using Type 1 channel access procedure, without applying a CP extension.

TABLE 4.2.1-1
Channel Access Priority Class (CAPC) for UL

| Channel | | | | | |
|---|---|---|---|---|---|
| Access | | | | | |
| Priority | | | | | allowed |
| Class (p) | mₚ | CW_{min, p} | CW_{max, p} | T_{ulm cot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, |
| | | | | 10 ms | 127, 255, |
| | | | | | 511, 1023} |
| 4 | 7 | 15 | 1023 | 6 ms or | {15, 31, 63, |
| | | | | 10 ms | 127, 255, |
| | | | | | 511, 1023} |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 us. The maximum duration before including any such gap shall be 6 ms.

### 4.2.1.0.1 Channel Access Procedures for Consecutive UL Transmission(s)

For contiguous UL transmission(s), the following are applicable:
If a UE is scheduled to transmit a set of UL transmissions using one or more UL grant(s) or DL assignment(s), and if the UE cannot access the channel for a transmission in the set prior to the last transmission according to one of Type 1, Type 2, or Type 2A UL channel access procedures, the UE shall attempt to transmit the next transmission according to the channel access type indicated in the corresponding UL grant or DL assignment. Otherwise, if the UE cannot access the channel for a transmission in the set prior to the last transmission according to Type 2B UL channel access procedure, the UE shall attempt to transmit the next transmission according to Type 2A UL channel access procedure.
If a UE is scheduled by a gNB to transmit a set of UL transmissions including PUSCH or SRS symbol(s) using a UL grant, the UE shall not apply a CP extension for the remaining UL transmissions in the set after the first UL transmission after accessing the channel.
If a UE is scheduled to transmit a set of consecutive UL transmissions without gaps including PUSCH using one or more UL grant(s), PUCCH using one or more DL grant(s), or SRS with one or more DL grant(s) or UL grant(s) and the UE transmits one of the scheduled UL transmissions in the set after accessing the channel according to one of Type 1, Type 2, Type 2A, Type 2B or Type 2C UL channel access procedures, the UE may continue transmission of the remaining UL transmissions in the set, if any.
If a UE is configured to transmit a set of consecutive PUSCH or SRS transmissions on resources configured by the gNB, the time domain resource configuration defines multiple transmission occasions, and if the UE cannot access the channel according to Type 1 UL channel access procedure for transmitting in a transmission occasion prior to the last transmission occasion, the UE shall attempt to transmit in the next transmission occasion according to Type 1 UL channel access procedure. If the UE transmits in one of the multiple transmission occasions after accessing the channel according to Type 1 UL channel access procedure, the UE may continue transmission in the remaining transmission occasions in the set, wherein each transmission occasion starts at the starting symbol of a configured grant PUSCH within the duration of the COT.
If a UE is configured by the gNB to transmit a set of consecutive UL transmissions without gaps including PUSCH, periodic PUCCH, or periodic SRS and the UE transmits one of the configured UL transmissions in the set after accessing the channel according to Type 1 UL channel access procedures, the UE may continue transmission of the remaining UL transmissions in the set, if any.

### 4.2.1.1 Type 1 UL Channel Access Procedure

This clause describes channel access procedures by a UE where the time duration spanned by the sensing slots that are sensed to be idle before a UL transmission(s) is random. The clause is applicable to the following transmissions:
PUSCH/SRS transmission(s) scheduled or configured by eNB/gNB, or
PUCCH transmission(s) scheduled or configured by gNB, or
Transmission(s) related to random access procedure.

A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2.
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step 4; else, go to step 5;

The defer duration T_{d} consists of duration T_{f}=16 us immediately followed by mₚ consecutive slot durations where each slot duration is Tₛₗ=9 us, and T_{f} includes an idle slot duration Tₛₗ at start of T_{f}.

### 4.2.1.2 Type 2 UL Channel Access Procedure

This clause describes channel access procedures by UE where the time duration spanned by the sensing slots that are sensed to be idle before a UL transmission(s) is deterministic.

If a UE is indicated by an eNB to perform Type 2 UL channel access procedures, the UE follows the procedures described in clause 4.2.1.2.1.

### 4.2.1.2.1 Type 2A UL Channel Access Procedure

If a UE is indicated to perform Type 2A UL channel access procedures, the UE uses Type 2A UL channel access procedures for a UL transmission. The UE may transmit the transmission immediately after sensing the channel to be idle for at least a sensing interval T_{short_ul}=25 us T_{short_ul} consists of a duration T_{f}=16 us immediately followed by one slot sensing slot and T_{f} includes a sensing slot at start of T_{f}. The channel is considered to be idle for T_{short_ul} if both sensing slots of T_{short_ul} are sensed to be idle.

### 4.2.1.2.2 Type 2B UL Channel Access Procedure

If a UE is indicated to perform Type 2B UL channel access procedures, the UE uses Type 2B UL channel access procedure for a UL transmission. The UE may transmit the transmission immediately after sensing the channel to be idle within a duration of T_{f}=16 us. T_{f} includes a sensing slot that occurs within the last 9 us of T_{f}. The channel is considered to be idle within the duration T_{f} if the channel is sensed to be idle for total of at least SUS with at least 4 us of sensing occurring in the sensing slot.

### 4.2.1.2.3 Type 2C UL Channel Access Procedure

If a UE is indicated to perform Type 2C UL channel access procedures for a UL transmission, the UE does not sense the channel before the transmission. The duration of the corresponding UL transmission is at most 584 us.

### ******************************* Quotation [5] End *********************************

In [6] 5G New Radio Unlicensed: Challenges and Evaluation, Mohammed Hirzallah, Marwan Krunz, Balkan Kecicioglu and Belal Hamzeh, a brief description for different kinds or types of LBT or channel access procedures are referenced.

### ******************************* Quotation [6] Start *********************************

LTE-LAA-/NR-U-based Systems: To facilitate 5G NR-U (also LTE-LAA) operation over unlicensed bands, four LBT Categories (CATs) have been defined:
CAT1-LBT (Type 2C): A gNB can access the channel immediately without performing LBT. The COT can be up to 584 microseconds.
CAT2-LBT (Type 2A and 2B): An NR-U device must sense the channel for a fixed time duration, Tfixed. If the channel remains idle during this period, the device can access the channel. In Type 2A, Tfixed is 25 microseconds, while in Type 2B, it is 16 microseconds.
CAT3-LBT: An NR-U device must back off for a random period of time before accessing the channel. This random period is sampled from a fixed-size contention window. The option of CAT3-LBT has been excluded from the specifications.
CAT4-LBT (Type 1): An NR-U device must back off according to the CSMA/CA procedure with exponential backoff

### ******************************* Quotation [6] End *********************************

In [7] RP-221938, “WID revision: NR sidelink evolution”, OPPO, justifications and objectives for performing SL transmission on unlicensed spectrum are introduced.

### ******************************* Quotation [7] Start *********************************

### 4.1 Objective of SI or Core Part WI or Testing Part WI

1. . . .
2. Study and specify support of sidelink on unlicensed spectrum for both mode 1 and mode 2 where Uu operation for mode 1 is limited to licensed spectrum only [RAN1, RAN2, RAN4]
   Channel access mechanisms from NR-U shall be reused for sidelink unlicensed operation
      Assess the applicability of sidelink resource reservation from Rel-16/Rel-17 to sidelink unlicensed operation within the boundaries of unlicensed channel access mechanism and operation
         No specific enhancements for Rel-17 resource allocation mechanisms
         If the existing NR-U channel access framework does not support the required SL-U functionality, WGs will make appropriate recommendations for RAN approval.
   Physical channel design framework: Required changes to NR sidelink physical channel structures and procedures to operate on unlicensed spectrum
      The existing NR sidelink and NR-U channel structure shall be reused as the baseline.
   No specific enhancements for existing NR SL feature
   The study should focus on FR1 unlicensed bands (n46 and n96/n102) and is to be completed by RAN #98.
   Note: In sidelink unlicensed operation, the gNB does not perform Type 1 channel access to initiate and share a channel occupancy, neither Type 2 channel access to share an initiated channel occupancy, nor semi-static channel access procedures to access an unlicensed channel.

### ******************************* Quotation [7] End *********************************

In RAN1 #110 ([8] RAN1 Chair's Notes of 3GPP TSG RAN WG1 #110), agreements on sidelink on unlicensed spectrum are provided.

### ******************************* Quotation [8] Start *********************************

### Agreement

Type 2A/2B/2C SL channel access procedures
   Type 2A channel access procedure is applicable to the following case:
      Transmission(s) by a UE following transmission(s) by another UE for a gap ≥25 μs in a shared channel occupancy
      FFS any other transmission by a UE (e.g., other than COT sharing)
      FFS whether Type 2A is used also for the case of short control signalling transmission
   Type 2B channel access procedure is applicable to the following case:
      Transmission(s) by a UE following transmission(s) by another UE at least when the gap is 16 ns in a shared channel occupancy
      FFS the case when the gap is between 16 and 25 us
      FFS any other transmission by a UE (e.g., other than COT sharing)
   Type 2C channel access procedure is applicable to the following case:
      Transmission(s) by a UE following transmission(s) by another UE for a gap ≤16 μs in a shared channel occupancy and the duration of the corresponding transmission is at most 584 us.
      FFS any other transmission by a UE (e.g., other than COT sharing)
      FFS whether Type 2C is used also for the case of short control signalling transmission
   FFS under which conditions (other than the gap) UEs can apply the Type 2A/2B/2C SL channel access procedures
   FFS under which conditions Type 2B or Type 2C is applied in case of a gap of 16 ns

### Agreement

Multi-consecutive slots transmission (MCSt) is supported for Mode 1 and Mode 2 resource allocation in SL-U.
FFS details

### Agreement

For PSCCH and PSSCH in SL-U:
Both R16/R17 NR SL contiguous RB-based and interlace RB-based transmissions similar to R16 NR-U are supported

### Agreement

For PSCCH and PSSCH resource indication in time/frequency domain:
For time domain: R16 NR SL TRIV is reused as baseline
For frequency domain:
   further study sub-channel indexing and resource indication
FFS: whether any enhancement needed on R16 NR SL TRIV/FRIV if new feature is introduced in SL-U, e.g., multi-slot consecutive transmission

### ******************************* Quotation [8] End *********************************

In RAN1 #110bis-e ([9] RAN1 Chair's Notes of 3GPP TSG RAN WG1 #110bis-e), agreements on sidelink on unlicensed spectrum are provided.

### ******************************* Quotation [9] Start *********************************

### Agreement

Type 1 SL channel access procedure is applicable to the following transmissions by a UE:
   PSSCH/PSCCH transmission(s) scheduled or configured by a gNB in SL Mode 1 resource allocation.
   PSSCH/PSCCH transmission(s) from the UE in SL Mode 2 resource allocation.
   Other SL transmissions including S-SSB and PSFCH transmissions from a UE
      FFS: how to set CAPC for S-SSB and PSFCH
   Note: Type 1 can be used to initiate a COT
A UE uses a channel access priority class applicable to the sidelink user plane data multiplexed in PSSCH for performing the Type 1 channel access procedures to transmit transmission(s) including PSSCH with user plane data and its associated PSCCH.
   Note: how to set CAPC for MAC CE multiplexed in PSSCH is up to RAN2
A UE shall not transmit on a channel for a Channel Occupancy Time that exceeds the maximum COT duration where the channel access procedures are performed based on a channel access priority class p associated with the UE transmissions, as given in CAPC table for SL.

### Agreement

On the support of MCSt operation in SL-U, following options are to be further studied and one or more of the following options will be selected in future meetings.
When L1 is triggered for reporting a subset of candidate resources for MCSt,
   Option 1: Only one set of parameters (prio_{TX}, remaining PDB, L_{subCH} and P_{rsvp_TX}) is provided for the resource selection procedure in L1
      Note, this is applicable for transmission of a single TB and multiple TBs
      FFS: whether this is the same or different than Rel-16
   Option 2: one or multiple sets of parameters (prio_{TX}, remaining PDB, L_{subCH} and P_{rsvp_TX}) are provided for the resource selection procedure in L1
   FFS: any further information needs to be provided to L1 for MCSt
When L1 reports a subset of candidate resources for MCSt,
   Option A: L1 reports candidate multi-slot resources in S A where a candidate multi-slot resource consists of a set of single-slot resources that are consecutive in time
      FFS whether the set of single-slot resources within a candidate multi-slot resource can have different L_{subCH} sizes
   Option B: L1 reports candidate single-slot resources in (S_{A}) as in Rel-16
      It is up to the higher (MAC) layer to select a set of single-slot resources that are consecutive in logical slots
   Option C: L1 reports consecutive single-slot candidate resources in S_{A}
      FFS whether the consecutive single-slot candidate resources can have different L_{subCH} sizes
   FFS: any further information needs to be reported to MAC layer, provided to L1 or utilized for MCSt
   FFS: whether/how to consider the additional LBT time in SL resource allocation

### Agreement

For dynamic channel access mode with multi-channel case in SL-U, NR-U UL channel access procedure is considered as baseline for transmission on multiple channels
FFS: whether transmission of PSFCH and/or S-SSB on a subset of RB sets is supported (using the NR-U DL channel access procedure as baseline)
FFS any necessary enhancement and modification for the SL-U operation

### Agreement

In Type 1 SL channel access procedure, the following table is adopted for channel access priority class (CAPC) for SL.
FFS: the applicability and usage of NOTE1 in the table
FFS: whether mp=1 can be used with p=1, and applicable cases

| Channel | | | | | |
|---|---|---|---|---|---|
| Access | | | | | |
| Priority | | | | | allowed |
| Class (p) | mp | CWmin, p | CWmax, p | Tslmcot, p | CWp sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms [or | {15, 31, 63, |
| | | | | 10 ms] | 127, 255, |
| | | | | | 511, 1023} |
| 4 | 7 | 15 | 1023 | 6 ms [or | {15, 31, 63, |
| | | | | 10 ms] | 127, 255, |
| | | | | | 511, 1023} |

[NOTE1:
For p = 3, 4, Tslmcot, p = 10 ms if the higher layer parameter absenceOfAnyOtherTechnology-r14 or absenceOfAnyOtherTechnology-r16 is provided, otherwise, Tslmcot, p = 6 ms.]
NOTE 2:
When Tslmcot, p = 6 ms it may be increased to 8 ms by inserting one or more gaps. The minimum duration of a gap shall be 100 μs. The maximum duration before including any such gap shall be 6 ms.

### Agreement

For PSCCH and PSSCH in SL-U:
PSCCH is transmitted within 1 sub-channel
At least support Option 1 below
   Option 1: PSCCH locates in the lowest sub-channel of lowest RB set of corresponding PSSCH
      Note: the lowest sub-channel may not be entirely contained in the lowest RB set FFS whether/how to handle the case where UEs supporting different bandwidths can use the same resource pool to communicate with each other, e.g., whether/how to additionally support Option 2 below
   Option 2: PSCCH locates in every RB set of corresponding PSSCH
Note: the above options do not imply any restriction on the mapping of sub-channels to PRBs.
FFS other details.

### ******************************* Quotation [9] End *********************************

In New Radio (NR) Rel-16, it is a first release for NR sidelink Vehicle-to-Everything (V2X), and the current standard has already met the requirement as defined in SA1. Considering the future, with more and more devices requiring higher throughput and higher data rate, sidelink transmission on wider frequency resources may be desired. However, current bands supporting PC5 interface or sidelink transmissions may not be enough. Thus, introduction of sidelink transmissions on unlicensed/shared spectrum with large spectrum availability may be one targeted solution. In order to have fair coexistence with other devices in the same or different RAT or different techniques (e.g., WiFi) in unlicensed spectrum, listen-before-talk (LBT) may be required. LBT is one energy detection or sensing technique, according to LBT result (which is idle or busy) before transmission, a device could determine whether the transmission is allowed. There is a short introduction of New Radio-Unlicensed for Uu interface in [5] 3GPP TS 37.213 V16.6.0 (2021-06) and [6] 5G New Radio Unlicensed: Challenges and Evaluation. LBT could briefly separate into short LBT (e.g., CAT1-LBT, and CAT2-LBT) and long LBT (e.g., CAT4-LBT). For short LBT, a device may be allowed to perform transmission without LBT or perform relatively short LBT; while for long LBT, a device may need to perform transmission with LBT with relatively longer time (e.g., with more sensing slots being idle and preferably with back off). Long LBT corresponds to type-1 channel access procedures in TS 37.213, and short LBT corresponds to type-2/2A/2B/2C channel access procedures in TS 37.213. While for sidelink reception, continuously monitoring or receiving or detecting sidelink resources may be one assumption in a sidelink device.

For NR Release-16/17 sidelink design, sidelink slots can be utilized for Physical Sidelink Broadcast Channel (PSBCH) or Physical Sidelink Control Channel (PSCCH)/Physical Sidelink Shared Channel (PSSCH)/Physical Sidelink Feedback Channel (PSFCH) transmission/reception. Moreover, the concept of sidelink resource pool for sidelink communications is utilized for PSCCH/PSSCH and/or PSFCH transmission/reception. A sidelink (communication) resource pool will comprise a set of sidelink slots (except slots for PSBCH) and a set of frequency resources. Different sidelink (communication) resource pools may be Time Division Multiplexed (TDMed) and/or Frequency Division Multiplexed (FDMed). More specifically, a PSCCH in one sidelink (communication) resource pool can only schedule PSSCH resource(s) in the same one sidelink (communication) resource pool. A PSCCH in one sidelink (communication) resource pool is not able to schedule PSSCH resource(s) in other/another sidelink (communication) resource pool. For a PSCCH/PSSCH, associated PSFCH is in the same sidelink (communication) resource pool, instead of in different sidelink (communication) resource pools.

One sidelink (communication) resource pool will comprise multiple sub-channels in frequency domain, wherein a sub-channel comprises multiple contiguous Physical Resource Blocks (PRBs) in frequency domain. One PRB comprises multiple Resource Elements (REs), e.g., one PRB consists of 12 REs. Configuration of the sidelink resource pool will indicate the number of PRBs of each sub-channel in the corresponding sidelink resource pool. Sub-channel based resource allocation in frequency domain is supported for PSSCH. For a PSSCH resource scheduled by a PSCCH in the same sidelink slot, a fixed relationship between the PSCCH and the PSSCH resource is specified, which means that the PSCCH will be located in the lowest (index of) sub-channel of the scheduled PSSCH resource. As for scheduled PSSCH resource in different slot(s), the starting frequency position of the scheduled PSSCH resource will be scheduled/indicated by sidelink control information, instead of a fixed relationship.

In current NR Release-16/17 sidelink design, one Sidelink Control Information (SCI) could indicate at most three PSSCH resources via Frequency resource assignment and/or Time resource assignment in the SCI. The SCI may comprise a 1st stage SCI and a 2nd stage SCI. The 1st stage SCI may be transmitted via PSCCH. The 2nd stage SCI may be transmitted via multiplexed with the scheduled PSSCH resource in the same sidelink slot, e.g., the first PSSCH resource. In other words, the SCI can schedule at most two PSSCH resources in later sidelink slots, e.g., the second PSSCH resource and/or the third PSSCH resource. The at most three PSSCH resources are in different slots in a sidelink (communication) resource pool. The at most three PSSCH resources are within 32 consecutive slots in a sidelink resource pool. The at most three PSSCH resources are utilized/associated with a same data packet, e.g., a same Transport Block (TB), or a same Medium Access Control (MAC) Protocol Data Unit (PDU).

When a receiving (RX) User Equipment (UE) receives the one SCI in a specific slot, the specific slot would be a reference slot or a first slot for determining the 32 consecutive slots in a sidelink (communication) resource pool. The first PSSCH resource is in the specific slot where the one SCI is received. The starting sub-channel of the first PSSCH resource is the sub-channel in which the PSCCH is received. Time resource assignment in the SCI would indicate a Time Resource Indicator Value (TRIV).

Moreover, resource reservation for another TB by a SCI could be (pre-)configured with enabled or not enabled or not configured in a sidelink (communication) resource pool. When a sidelink (communication) resource pool is configured with an enabled resource reservation, the sidelink (communication) resource pool is configured with a set of reservation period values. Possible reservation periods could be 0, 1:99, 100, 200, 300, 400, 500, 600, 700, 800, 900, 1000 ms. A resource reservation period field in a SCI in the sidelink (communication) resource pool could indicate which reservation period value is for (future) resource reservation. The size/number of the set of reservation period values could be from 1 to 16.

In current NR Release-16/17 sidelink design, there are two sidelink resource allocation modes defined for NR sidelink communication:
Mode 1 is that the base station/network node can schedule sidelink resource(s) to be used by the UE for sidelink transmission(s);
Mode 2 is that the UE determines (i.e., base station/network node does not schedule) sidelink transmission resource(s) within sidelink resources configured by the base station/network node or pre-configured sidelink resources.

For UE (autonomous) selection mode, e.g., NR sidelink resource allocation mode 2, since transmission resource is not scheduled via a network node, the UE may require performing sensing before selecting a resource for transmission (e.g., sensing-based transmission), in order to avoid resource collision and interference from or to other UEs (especially UEs using Long Term Evolution (LTE)/NR sidelink). Full sensing is supported in NR Rel-16 sidelink, while partial sensing is supported in NR Rel-17 sidelink. Based on the result of the sensing procedure, Physical layer (L1) of the UE can determine a valid/identified resource set. The valid/identified resource set may be reported to a higher layer (Medium Access Control (MAC) layer) of the UE. The higher layer (MAC layer) of UE may (randomly) select one or multiple valid/identified resources, from the valid/identified resource set, to perform sidelink transmission(s) from the UE. The sidelink transmission(s) from the UE may be PSCCH and/or PSSCH transmission.

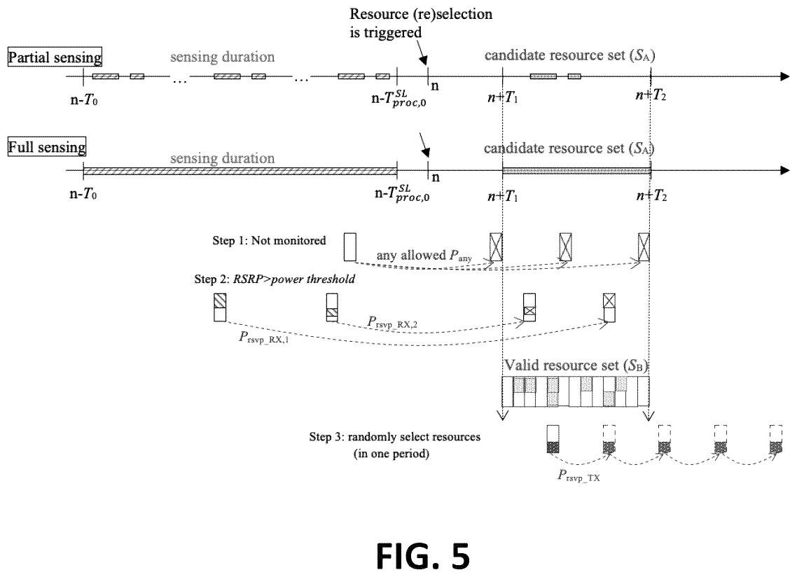

As an instance shown in FIG. 5, when sensing-based resource selection is triggered/requested in slot n, (the Physical layer of) the UE will have a (initial) set of candidate single-slot resources comprising multiple candidate single-slot resources. The available (initial) set of candidate single-slot resources is restricted with time interval [n+T₁, n+T₂], which may be called a resource selection window. Preferably in certain embodiments, one candidate single-slot resource may comprise one or multiple frequency resource units within one slot, wherein the frequency resource unit may be a sub-channel. As specified in TS 38.214 [2] 3GPP TS 38.214 V17.1.0 (2022-03), a candidate single-slot resource for transmission R_{x,y} is defined as a set of L_{subCH} contiguous sub-channels with sub-channel x+j in slot t′_{y}^{SL} where j=0, . . . , L_{subCH}−1.

If full sensing is performed (e.g., [2] 3GPP TS 38.214 V17.1.0 (2022-03)), e.g., partial sensing is not configured, the (initial) set of candidate single-slot resources are in the (full) time interval [n+T₁,n+T₂]. The (Physical layer of the) UE shall monitor/sense slots within the sensing window [n−T₀, n−T_{proc,0}^{SL}).

Based on the sensing result, (the Physical layer of) the UE may generate a valid/identified resource set, wherein the valid/identified resource set is a subset of the (initial) set of candidate single-slot resources. The generation of the valid/identified resource set may be performed via excluding some candidate single-slot resources from the (initial) set of candidate single-slot resources, for instance the step 1 and step 2 shown in FIG. 5. If remaining candidate single-slot resources after exclusion steps is smaller than X (e.g., either of 20%, 35%, 50% depending on prio_{TX}, which association is configured in sidelink resource pool configuration) of the number of the (initial) set of candidate single-slot resources, the UE may re-perform the exclusion step via increasing power threshold by 3 dB. After then, (the Physical layer of) the UE can determine the valid/identified resource set. The resource selection for sidelink transmission, performed by the higher layer (MAC layer) of the UE, may be randomly selected from the valid/identified resource set, for instance the step 3 shown in FIG. 5.

As specified in [2] 3GPP TS 38.214 V17.1.0 (2022-03), the first excluding step is that if (the Physical layer of) the UE does not monitor/sense a Transmission Time Interval (TTI) z, (the Physical layer of), the UE cannot expect whether the candidate single-slot resources in TTI “z+P_{any}” are occupied or not, wherein P_{any} means any possible periodicity configured in the sidelink (communication) resource pool. For instance, the first excluding step is shown as the step 1 in FIG. 5. The (Physical layer of) UE excludes the candidate single-slot resources in TTI “z+q·P_{any}” and excludes the candidates single-slot resources for which other UE(s) may have possible transmission occurring in TTI “z+q·P_{any}”, wherein q is 1 or 1, 2, . . . ,

$$⌈ \frac{{T}_{s c a l}}{{P}_{rsvp \_ RX}} ⌉ .$$

The parameter q means that the UE excludes multiple candidate single-slot resources with period P_{rsvp_RX} within a time interval [z, z+T_{scal}].

The second excluding step is that if (the Physical layer of) the UE receives/detects a sidelink control signaling (e.g., SCI format 1) in a TTI m, (the Physical layer of) the UE may exclude the candidate single-slot resources according to the received sidelink control signaling. For instance, the second excluding step is shown as the step 2 in FIG. 5. More specifically, if (the Physical layer of) the UE receives/detects a sidelink control signaling scheduling a transmission in a TTI m and the measurement result for the sidelink control signaling is higher than a power threshold, (the Physical layer of) the UE may exclude the candidate single-slot resources according to the received sidelink control signaling. The measurement result may be Reference Signal Received Power (RSRP). More specifically, the measurement result may be PSCCH-RSRP or PSSCH-RSRP. The sidelink control signaling may schedule/indicate the resources of the scheduled transmission and/or periodicity of the scheduled transmission, P_{rsvp_RX}. The excluded candidate single-slot resources according to the received sidelink control signaling are the resources of a next one or multiple scheduled transmission(s) based on the resources of the scheduled transmission and/or periodicity of the scheduled transmission. The next multiple scheduled transmissions may be with period P_{rsvp_RX} within a time interval [z, z±T_{scal}]. The power threshold is determined based on prio_{RX} (priority value indicated by the received sidelink control signaling) and prior_{TX} (priority value provided by the UE's higher layer). The association between the power threshold and (prio_{RX}, prior_{TX}) is configured by the higher layer (e.g., configuration of the sidelink (communication) resource pool).

With regards to sidelink transmission on unlicensed/shared spectrum, a transmitting (TX) UE may be required to perform a sidelink (SL) channel access procedure for following sidelink transmission from the TX UE. The SL channel access procedure is performed for occupying the channel. When/if the TX UE does not pass LBT for initiating a Channel Occupancy Time (COT) (e.g., pass Type 1 SL channel access procedure) or sharing/utilizing a COT (e.g., pass Type 2A/2B/2C SL channel access procedure), the TX UE may not be able to perform the following sidelink transmission. When/if the TX UE passes LBT for initiating a COT (e.g., pass Type 1 SL channel access procedure) or sharing/utilizing a COT (e.g., pass Type 2A/2B/2C SL channel access procedure), the TX UE may be able to perform the following sidelink transmission(s). Moreover, any time gap between the following sidelink transmission(s) may possibly induce some chances for other Radio Access Technology (RAT(s)) or UE(s) to occupy the channel, which induce that the TX UE may not be able to continue its own sidelink transmission(s). Thus, it is agreed to support multi-consecutive slots transmission (MCSt) for Mode 1 and Mode 2 resource allocation in SL-U (e.g., [8] RAN1 Chair's Notes of 3GPP TSG RAN WG1 #110).

On the support of MCSt operation in mode 2, it is for the TX UE to achieve selecting multiple sidelink resources in multi-consecutive slots, which can mitigate the impact of channel interruption due to other RAT(s) or UE(s). The multi-consecutive slots may mean at least multi-consecutive sidelink slots. More strictly, the multi-consecutive slots may mean multi-consecutive physical slots. The multi-consecutive physical slots will be consecutive in time domain. In RAN1 #110bis-e meeting (e.g., [9] RAN1 Chair's Notes of 3GPP TSG RAN WG1 #110bis-e), one or more of the following options are for further study to support MCSt operation in SL-U mode 2 (note that other options are not excluded):
When L1 is triggered for reporting a subset of candidate resources for MCSt,
   Option 1: Only one set of parameters (prio_{TX}, remaining Packet Delay Budget (PDB), L_{subCH} and P_{rsvp_TX}) is provided for the resource selection procedure in L1.
      Note, this is applicable for transmission of a single TB and multiple TB s.
      FFS: whether this is the same or different than Rel-16.
   Option 2: one or multiple sets of parameters (prio_{TX}, remaining PDB, L_{subCH} and P_{rsvp_TX}) are provided for the resource selection procedure in L1.
When L1 reports a subset of candidate resources for MCSt,
   Option A: L1 reports candidate multi-slot resources in S_{A} where a candidate multi-slot resource consists of a set of single-slot resources that are consecutive in time.
      PBS (for further study) whether the set of single-slot resources within a candidate multi-slot resource can have different L_{subCH} sizes.
   Option B: L1 reports candidate single-slot resources in (S_{A}) as in Rel-16
      It is up to the higher (MAC) layer to select a set of single-slot resources that are consecutive in logical slots.
   Option C: L1 reports consecutive single-slot candidate resources in S_{A}
      PBS whether the consecutive single-slot candidate resources can have different L_{subCH} sizes.

In option A, the physical layer of the TX UE may design/consider a candidate multi-slot resource as a set of multiple candidate single-slot resources that are consecutive in multi-consecutive slots. Each of the multiple candidate single-slot resources for the candidate multi-slot resource may comprise the same or a different number of sub-channel(s). The physical layer of the TX UE may perform resource exclusion in unit of candidate multi-slot resource, and then report valid/identified candidate multi-slot resources to the higher layer of the TX UE. One issue is how the physical layer of the TX UE determines the number of the multiple candidate single-slot resources or the number of the multi-consecutive slots for one candidate multi-slot resource, noted as L_{MCSt}. Another issue is how to note/define a candidate multi-slot resource, wherein one concern is that each of the multiple candidate single-slot resources for the candidate multi-slot resource may comprise a different number of sub-channel(s), and another concern is that each of the multiple candidate single-slot resources for the candidate multi-slot resource may be associated from the same or different starting sub-channel index (even with same number of sub-channel(s)). The notion/definition of a candidate multi-slot resource may be related to the counting on the number of candidate multi-slot resources and/or also the ending condition of resource exclusion (satisfying≥X·Mₜₒₜₐₗ). Exhaustive methods will be quite complex and non-efficient, since the complexity and corresponding number/counting will increase drastically for increasing L_{MCSt}.

To deal with the above issues on MCSt in mode 2, some concepts, mechanisms, methods, and/or embodiments are provided in the following disclosure.

In a first slot n, the (physical layer of) TX UE may trigger/request or be triggered/requested sensing-based resource (re-)selection for performing PSSCH/PSCCH transmission(s) in a sidelink resource pool in unlicensed/shared spectrum. The PSSCH/PSCCH transmission(s) may be utilized for transmitting a sidelink data packet to at least a first RX UE, which is associated with a first destination identity. Preferably in certain embodiments, the (physical layer of) TX UE may trigger/request or be triggered/requested to determine a subset of sidelink resources from which the higher layer of the TX UE will select sidelink resources for PSSCH/PSCCH transmission(s). Preferably in certain embodiments, the (physical layer of) TX UE may determine the subset of sidelink resources and report the subset of sidelink resources to the higher layer of the TX UE. The higher layer of the TX UE will select sidelink resources for PSSCH/PSCCH transmission(s) from the subset of sidelink resources. The higher layer of the TX UE may provide any parameters of information of the sidelink resource pool from which the sidelink resources are to be reported, priority (noted as prio_{TX}), remaining packet delay budget (PDB), the number of sub-channels to be used for the PSSCH/PSCCH transmission in a slot (noted as L_{subCH}), or the resource reservation interval (noted as P_{rsvp_RX}).

### Concept A

For MCSt operation, the (physical layer of) TX UE may determine/derive/obtain/have a first parameter (noted as L_{MCSt}). The (physical layer of) TX UE may determine the subset of sidelink resources based on the first parameter.

Preferably in certain embodiments, the first parameter may be associated with more than one value used to derive/determine/set valid/possible/allowed length of consecutive slots (e.g., (1) two values used for indicating upper and lower boundary of a length range or used for indicating a starting value plus length value; or (2) two or three values directly indicating different lengths; or (3) deriving/selecting/determining one value from the more than one value).

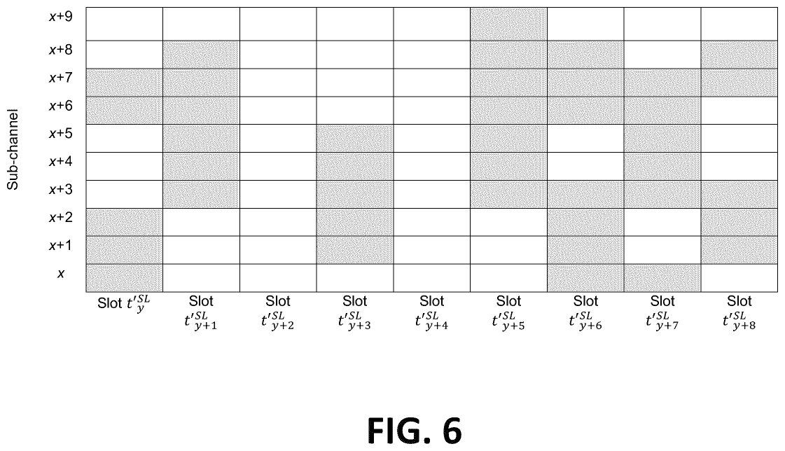

Preferably in certain embodiments, the first parameter (L_{MCSt}) may be utilized for determining/setting/initializing candidate multi-slot resources. Preferably in certain embodiments, each candidate multi-slot resource comprises or consists of L_{MCSt} candidate single-slot resources that are consecutive in time. The L_{MCSt} candidate single-slot resources of/for one candidate multi-slot resource are separated/distributed in L_{MCSt} consecutive slots. Preferably in certain embodiments, the L_{MCSt} candidate single-slot resources of/for the one candidate multi-slot resource may comprise the same frequency resources (e.g., comprises same sub-channels, or comprising same starting sub-channel and same number/length of sub-channel). Preferably and/or alternatively, the L_{MCSt} candidate single-slot resources of/for the one candidate multi-slot resource may comprise the same or different frequency resources (e.g., comprises same or different sub-channels). Preferably in certain embodiments, different candidate multi-slot resources may comprise the same or different candidate single-slot resources. The (physical layer of the) TX UE may exclude some candidate multi-slot resources based on received SCI(s) and/or non-monitoring slot(s). For instance, if/when part or full/all of a specific candidate single-slot resource is indicated as reserved by other UEs, the (physical layer of the) TX UE may exclude some candidate multi-slot resources, wherein the excluded some candidate multi-slot resources comprises the specific single-slot resource. Preferably in certain embodiments, the (physical layer of) TX UE may report remaining candidate multi-slot resources after exclusion steps/operations based on received SCI(s) and/or non-monitoring slot(s). For instance, as shown in FIG. 6, the gray blocks may mean sidelink resources not reserved/scheduled/allocated by other UE(s) or not excluded in exclusion steps/operations. Assuming L_{subCH}=3 and L_{MCSt}=3, a candidate multi-slot resource R_{(x1,x2,x3),y} may be defined as L_{MCSt}=3 candidate single-slot resources, which comprises a first set of L_{subCH} contiguous sub-channels with sub-channel x1+j in slot t′_{y}^{SL}, a second set of L_{subCH} contiguous sub-channels with sub-channel x2+j in slot t′_{y+1}^{SL}, and a third set of L_{subCH} contiguous sub-channels with sub-channel x3+j in slot t′_{y+2}^{SL}, where j=0, . . . , L_{subCH}−1. The physical layer of the TX UE may report valid/identified candidate multi-slot resources comprising R_{(x+a,x+b,x+c),y+5}, wherein a=3˜7, b=0, 1, 6, c=3˜5. The physical layer of the TX UE may report valid/identified candidate multi-slot resources comprising R_{(x+a,x+b,x+c),y+6}, wherein a=0, 1, 6, b=3˜5, c=1.

Preferably and/or alternatively, the first parameter (L_{MCSt}) may be utilized for excluding candidate single-slot resources that are not consecutive in time. Preferably in certain embodiments, the first parameter (L_{MCSt}) may be utilized for excluding candidate single-slot resources that are not consecutive in L_{MCSt} consecutive slots. Preferably in certain embodiments, the first parameter (L_{MCSt}) may be utilized for excluding candidate single-slot resources in some candidate slots. Preferably in certain embodiments, after the TX UE excludes candidate single-slot resources based on received SCI(s) and/or non-monitoring slot(s), the TX UE excludes candidate single-slot resources in some candidate slots based on the first parameter (L_{MCSt}). Preferably in certain embodiments, when/after the TX UE determines/derives valid/identified candidate single-slot resources according to (the exclusion based on) the received SCI(s) and/or the non-monitoring slot(s), the TX UE (checks consecution of the valid/identified candidate single-slot resources and) excludes valid/identified candidate single-slot resources in the some candidate slots based on the first parameter (L_{MCSt}). Preferably in certain embodiments, the some candidate slots are not consecutive in time. Preferably and/or alternatively, consecution of the some candidate slots is smaller/less than L_{MCSt}. Preferably in certain embodiments, the subset of sidelink resources reported to the higher layer of the TX UE does not comprise the (valid/identified) candidate single-slot resources in the some candidate slots. For an instance, as shown in FIG. 6, if L_{MCSt} is 3, the valid/identified candidate single-slot resources in slot t′_{y+3}^{SL} are excluded, since slot t′_{y+3}^{SL} is not consecutive with other candidate slots with valid/identified candidate single-slot resources. The valid/identified candidate single-slot resources in slot t′_{y}^{SL} and t′_{y+1}^{SL} are excluded, since consecution of slot t′_{y}^{SL} and t′_{y+1}^{SL} is 2 (the two consecutive slots are not consecutive with other candidate slots with valid/identified candidate single-slot resources).

Preferably and/or alternatively, the first parameter (L_{MCSt}) may be utilized for not reporting (to the higher layer of the TX UE) candidate single-slot resources that are not consecutive in time. Preferably in certain embodiments, the first parameter (L_{MCSt}) may be utilized for not reporting (to the higher layer of the TX UE) candidate single-slot resources that are not consecutive in L_{MCSt} consecutive slots. Preferably in certain embodiments, the first parameter (L_{MCSt}) may be utilized for not reporting (to the higher layer of the TX UE) candidate single-slot resources in some candidate slots. Preferably in certain embodiments, after the TX UE excludes candidate single-slot resources based on received SCI(s) and/or non-monitoring slot(s), the TX UE does not report (to the higher layer of the TX UE) candidate single-slot resources in the some candidate slots based on the first parameter (L_{MCSt}). Preferably in certain embodiments, when/after the TX UE determines/derives valid/identified candidate single-slot resources according to (the exclusion based on) the received SCI(s) and/or the non-monitoring slot(s), the TX UE (checks consecution of the valid/identified candidate single-slot resources and) does not reports (to the higher layer of the TX UE) valid/identified candidate single-slot resources in the some candidate slots based on the first parameter (L_{MCSt}). Preferably in certain embodiments, the some candidate slots are not consecutive in time. Preferably and/or alternatively, consecution of the some candidate slots is smaller/less than L_{MCSt}. Preferably in certain embodiments, the subset of sidelink resources reported to the higher layer of the TX UE does not comprise the (valid/identified) candidate single-slot resources in the some candidate slots. For an instance shown in FIG. 6, if L_{MCSt} is 3, the valid/identified candidate single-slot resources in slot t′_{y+3}^{SL} are not reported to the higher layer of the TX UE, since slot t′_{y+3}^{SL} not consecutive with other candidate slots with valid/identified candidate single-slot resources. The valid/identified candidate single-slot resources in slot t′_{y}^{SL} and t′^{y+1}^{^{SL}} are not reported to the higher layer of the TX UE, since consecution of slot t′_{y}^{SL} and t′_{y}^{SL+1} is 2 (the two consecutive slots are not consecutive with other candidate slots with valid/identified candidate single-slot resources).

In one embodiment, the higher layer (e.g., MAC layer) of the TX UE may provide the first parameter to the (physical layer of) TX UE, e.g., when the higher layer (e.g., MAC layer) of the TX UE triggers/requests the (Physical layer of) TX UE to determine the subset of sidelink resources. Preferably in certain embodiments, the higher layer (e.g., MAC layer) of the TX UE may determine the first parameter based on a configuration associated with a sidelink logical channel, wherein the sidelink data packet comprises sidelink data from the sidelink logical channel Preferably in certain embodiments, the higher layer (e.g., MAC layer) of the TX UE may determine the first parameter based on a MAC CE, wherein the sidelink data packet comprises the MAC CE. Preferably in certain embodiments, the higher layer (e.g., MAC layer) of the TX UE may determine the first parameter based on a (expected) number of PSCCH/PSSCH transmissions for transmitting the sidelink data packet. Preferably in certain embodiments, the (expected) number of PSCCH/PSSCH transmissions may comprise/mean PSCCH/PSSCH retransmissions for the sidelink data packet. Preferably and/or alternatively, the (expected) number of PSCCH/PSSCH transmissions may comprise/mean PSCCH/PSSCH initial transmission and retransmissions for the sidelink data packet. Preferably in certain embodiments, the higher layer (e.g., MAC layer) of the TX UE may determine the first parameter based on a number/amount of (pending) sidelink data packets, wherein the PSSCH/PSCCH transmission(s) may be utilized for transmitting the number/amount of (pending) sidelink data packets.

In one embodiment, the first parameter may be configured in a configuration of the sidelink resource pool. Preferably in certain embodiments, the first parameter may be configured in the configuration of the sidelink resource pool supporting/enabling multi-consecutive slots transmission operation.

In one embodiment, the first parameter may be configured in a configuration of sidelink connection. The sidelink connection may be associated with a destination (identity). Preferably in certain embodiments, the first parameter may be determined/derived based on a configuration of sidelink connection associated with the first destination identity. The sidelink connection may be for unicast or groupcast.

In one embodiment, the first parameter may be determined/derived based on the priority (prio_{TX}) and/or the remaining packet delay budget (PDB). Preferably in certain embodiments, the mapping/association between the first parameter and the priority may be configured, e.g., configured in a configuration of the sidelink resource pool, or configured in a configuration of sidelink connection. Preferably in certain embodiments, the mapping/association between the first parameter and the remaining PDB may be configured, e.g., configured in a configuration of the sidelink resource pool, or configured in a configuration of sidelink connection.

In one embodiment, the first parameter may be determined/derived based on a Channel Access Priority Class (CAPC). Preferably in certain embodiments, the CAPC may be determined/derived based on the priority (prio_{TX}). Preferably in certain embodiments, the mapping/association between the first parameter and the CAPC may be configured, e.g., configured in a configuration of the sidelink resource pool, or configured in a configuration of sidelink connection. Preferably in certain embodiments, the higher layer (e.g., MAC layer) of the TX UE may provide the CAPC to the (physical layer of) TX UE, e.g., when the higher layer (e.g., MAC layer) of the TX UE triggers/requests the (Physical layer of) TX UE to determine the subset of sidelink resources.

In one embodiment, the first parameter may be determined/derived based on a (time length of) COT duration. The COT duration may be determined/derived based on the CAPC. The COT duration may be initialized by the TX UE. Preferably in certain embodiments, the mapping/association between the first parameter and the (time length of) COT duration may be configured, e.g., configured in a configuration of the sidelink resource pool, or configured in a configuration of sidelink connection. Preferably in certain embodiments, the first parameter may be determined/derived as a number of slots of the (time length of) COT duration. The motivation is that TX UE is not allowed to perform sidelink transmission outside the COT duration. Preferably and/or alternatively, the first parameter may be determined/derived as an offset plus the number of slots of the (time length of) COT duration. The offset may be configured or specified or determined by the TX UE itself. The motivation of the offset is to consider possibility of LBT failure such that the TX UE may not be able to use all selected sidelink resources for performing PSSCH/PSCCH transmission(s).

In one embodiment, the first parameter may be determined/derived based on remaining (time length of) shared COT duration. Preferably in certain embodiments, the shared COT may be shared by other UE(s). Preferably in certain embodiments, the mapping/association between the first parameter and the remaining (time length of) shared COT duration may be configured, e.g., configured in a configuration of the sidelink resource pool, or configured in a configuration of sidelink connection. Preferably in certain embodiments, the first parameter may be determined/derived as a number of slots of the remaining (time length of) shared COT duration. The motivation is that the TX UE is not allowed to perform sidelink transmission outside the shared COT duration.

In one embodiment, the first parameter may be determined/derived based on Channel Busy Rate (CBR) of the sidelink resource pool. Preferably in certain embodiments, the mapping/association between the first parameter and the CBR may be configured, e.g., configured in a configuration of the sidelink resource pool. The motivation is that when the CBR is higher (e.g., the channel is too congested), the TX UE is not allowed to occupy sidelink resources too much longer in time.

In one embodiment, the (physical layer of the) TX UE may determine/derive the first parameter value (e.g., from a number of configured/available/specified values) based on a sensing result. Preferably in certain embodiments, the (physical layer of the) TX UE may determine/derive the first parameter (e.g., from a number of configured/available/specified values for the first parameter) based on remaining candidate single-slot resources after exclusion steps/operations based on received SCI(s) and/or non-monitoring slot(s). Preferably in certain embodiments, the (physical layer of the) TX UE may determine/derive the first parameter (e.g., from a number of configured/available/specified values for the first parameter) based on consecution of the remaining candidate single-slot resources after exclusion steps/operations. Preferably in certain embodiments, the (physical layer of the) TX UE may determine/derive the first parameter which can satisfy the condition check in concept D. Preferably in certain embodiments, the (physical layer of the) TX UE may determine/derive a maximum/largest value (e.g., from the number of configured/available/specified values), which can satisfy the condition check that the number of remaining candidate (single-slot or multi-slot) resources after exclusion steps is not smaller than X·Mₜₒₜₐₗ, as the first parameter. Preferably and/or alternatively, the (physical layer of the) TX UE may determine/derive a maximum/largest value (e.g., from the number of configured/available/specified values), which can satisfy the condition check in concept D, as the first parameter.

Preferably in certain embodiments, if/when MCSt operation is not applied/performed, the (physical layer of) TX UE may not determine/derive the first parameter. The (physical layer of) TX UE may determine the subset of sidelink resources without basing on the first parameter.

Preferably in certain embodiments, based on the first parameter present or provided to the TX UE, or the first parameter with L_{MCSt} is larger than 1,
MCSt operation is applied/performed, and/or
Exclusion of candidate single-slot resources (that is not consecutive in time) is performed/applied, and/or
Not reporting candidate single-slot resources (that is not consecutive in time).

Preferably in certain embodiments, based on the first parameter not present or not provided to TX UE, or the first parameter with L_{MCSt} is being as 1 (if the first parameter is present or provided to TX UE),
MCSt operation is NOT applied/performed, and/or
Exclusion of candidate single-slot resources (that is not consecutive in time) is NOT performed/applied, and/or
Reporting candidate single-slot resources (that is or is not consecutive in time).

For MCSt operation, the (physical layer of) TX UE may exclude some candidate sidelink resources based on a specific condition. Preferably in certain embodiments, the (physical layer of) TX UE may not report, to the higher layer of the TX UE, some (valid/identified) candidate sidelink resources based on the specific condition. Preferably in certain embodiments, the higher layer of the TX UE may prevent/preclude/avoid/exclude to select some (valid/identified) candidate sidelink resources based on the specific condition. Preferably in certain embodiments, the some (valid/identified) candidate sidelink resources may mean/be some (valid/identified) candidate single-slot resources. Preferably and/or alternatively, the some (valid/identified) candidate sidelink resources may mean/be some (valid/identified) candidate multi-slot resources, e.g., described in concept A.

In one embodiment, the specific condition may be to guarantee/ensure utilizing clear channel(s) for performing the PSSCH/PSCCH transmission(s). Preferably in certain embodiments, the specific condition may be the (valid/identified) candidate sidelink resources are in the same one Resource Block (RB) set in the sidelink resource pool. Preferably and/or alternatively, the specific condition may be the (valid/identified) candidate sidelink resources are in the same one or more RB sets in the sidelink resource pool. Preferably in certain embodiments, for the set of (valid/identified) candidate sidelink resources selected/determined by the higher layer (MAC layer) of the TX UE, occupied RB set(s) cannot be increasing. More specifically, the set of (valid/identified) candidate sidelink resources selected/determined by the higher layer (MAC layer) of the TX UE comprises a first candidate sidelink resource in a first slot and a second candidate sidelink resource in a second slot, wherein the second slot is later than the first slot in time. The first candidate sidelink resource occupies the first one or more RB set(s), and the second candidate sidelink resource occupies the second one or more RB set(s). The specific condition may be that the first one or more RB set(s) comprises the second one or more RB set(s) (in frequency domain). The specific condition may be that the second one or more RB set(s) is not allowed to comprise any RB set out of the first one or more RB set(s) (in frequency domain).

Preferably in certain embodiments, the total number of (initialized) candidate multi-slot resources (before exclusion steps) may be noted as Mₘᵤₗₜᵢ₋ₜₒₜₐₗ. The (physical layer of) TX UE may exclude some candidate multi-slot resources based on received SCI(s) and/or non-monitoring slot(s). Preferably in certain embodiments, the (physical layer of) TX UE may perform condition check whether the number of remaining candidate multi-slot resources after exclusion steps is smaller than X·Mₘᵤₗₜᵢ₋ₜₒₜₐₗ. If the number of the remaining candidate multi-slot resources after exclusion steps is not smaller than X·Mₘᵤₗₜᵢ₋ₜₒₜₐₗ, the remaining candidate multi-slot resources after exclusion steps can be considered as valid/identified candidate multi-slot resources and reported to the higher layer of the TX UE. If the number of the remaining candidate multi-slot resources after exclusion steps is smaller than X·Mₘᵤₗₜᵢ₋ₜₒₜₐₗ, the (physical layer of the) TX UE will re-initialize candidate multi-slot resources and then perform exclusion steps based on received SCI from other UE(s) with increased RSRP threshold. In one embodiment, the sidelink resource pool in unlicensed/shared spectrum may comprise one or more RB sets. The (physical layer of) TX UE may perform sensing in the sidelink resource pool.

Preferably in certain embodiments, the (physical layer of) TX UE may perform sensing on all of the one or more RB sets in the sidelink resource pool. The sidelink resources/sub-channels in the one or more RB sets may be initialized as candidate single-slot resources. Preferably in certain embodiments, Mₜₒₜₐₗ may be the total number of (initialized) candidate single-slot resources in all of the one or more RB sets. The (physical layer of) the TX UE may perform condition check whether the number of remaining candidate single-slot resources after exclusion steps is smaller than X·Mₜₒₜₐₗ. Preferably and/or alternatively, the sidelink resources/sub-channels in the one or more RB sets may be initialized as candidate multi-slot resources. Mₘᵤₗₜᵢ₋ₜₒₜₐₗ may be the total number of (initialized) candidate multi-slot resources in all of the one or more RB sets. The (physical layer of) TX UE may perform condition check whether the number of remaining candidate multi-slot resources after exclusion steps is smaller than X·Mₘᵤₗₜᵢ₋ₜₒₜₐₗ.

Preferably and/or alternatively, the (physical layer of) TX UE may perform sensing on part of the one or more RB sets in the sidelink resource pool. (For instance, the sidelink resource pool comprises RB set 1,2,3, and the TX UE only performs sensing on RB set 1, or on RB sets 1 and 2.) The sidelink resources/sub-channels in the part of the one or more RB sets or in the RB set(s) which the TX UE performs sensing may be initialized as candidate single-slot resources. Preferably in certain embodiments, Mₜₒₜₐₗ may be the total number of (initialized) candidate single-slot resources in the part of the one or more RB sets or in the RB set(s) which the TX UE performs sensing. The (physical layer of) TX UE may perform condition check whether the number of remaining candidate single-slot resources after exclusion steps is smaller than X·Mₜₒₜₐₗ. Preferably and/or alternatively, the sidelink resources/sub-channels in the part of the one or more RB sets or in the RB set(s) which the TX UE performs sensing may be initialized as candidate multi-slot resources. Mₘᵤₗₜᵢ₋ₜₒₜₐₗ may be the total number of (initialized) candidate multi-slot resources in the part of the one or more RB sets or in the RB set(s) which the TX UE performs sensing. The (physical layer of) TX UE may perform condition check whether the number of remaining candidate multi-slot resources after exclusion steps is smaller than X·Mₘᵤₗₜᵢ₋ₜₒₜₐₗ.

For all of the above and herein concepts, methods, alternatives, and embodiments, the following teachings can be implemented. Further, note that any of the above and herein concepts, methods, alternatives, and embodiments may be combined or applied simultaneously.

Preferably in certain embodiments, the RB set may be/mean/comprise/change/represent/replace as LBT band or LBT unit. The RB set regards frequency resources in frequency domain.

Preferably in certain embodiments, sidelink control information for PSSCH may be transmitted/delivered via 1st stage SCI and 2nd stage SCI. Preferably in certain embodiments, the sidelink control information for PSSCH may be delivered at least in PSCCH. Preferably in certain embodiments, the sidelink control information for PSSCH may comprise 1st stage SCI. Preferably in certain embodiments, the 1st stage SCI may be transmitted via PSCCH. Preferably in certain embodiments, the sidelink control information for PSSCH may comprise 2nd stage SCI. Preferably in certain embodiments, the 2nd stage SCI may be transmitted via multiplexed with PSSCH. Preferably in certain embodiments, the SCI format 1 or SCI format 1-X is 1st stage SCI. Preferably in certain embodiments, the SCI format 2-A or 2-B or 2-C or 2-X is a 2nd stage SCI.

Preferably in certain embodiments, for transmitting PSSCH in a slot or sub-slot, the TX UE needs to transmit SCI in the slot or the sub-slot for scheduling the PSSCH.

Preferably in certain embodiments, the slot may mean a sidelink slot. Preferably in certain embodiments, the slot may be represented/replaced as a TTI.

Preferably in certain embodiments, the sidelink slot may mean slot for sidelink. Preferably in certain embodiments, a TTI may be a subframe (for sidelink) or slot (for sidelink) or sub-slot (for sidelink). Preferably in certain embodiments, a TTI comprises multiple symbols, e.g., 12 or 14 symbols. Preferably in certain embodiments, a TTI may be a slot (fully/partially) comprising sidelink symbols. Preferably in certain embodiments, a TTI may mean a transmission time interval for a sidelink (data) transmission. Preferably in certain embodiments, a sidelink slot or a slot for sidelink may contain all Orthogonal Frequency Division Multiplexing (OFDM) symbols available for sidelink transmission. Preferably in certain embodiments, a sidelink slot or a slot for sidelink may contain a consecutive number of symbols available for sidelink transmission. Preferably in certain embodiments, a sidelink slot or a slot for sidelink means that a slot is included/comprised in a sidelink resource pool.

Preferably in certain embodiments, the symbol may mean a symbol indicated/configured for sidelink.

Preferably in certain embodiments, the slot may mean/comprise a sidelink slot associated with the (sidelink) resource pool. Preferably in certain embodiments, the slot may not mean/comprise a sidelink slot associated with other (sidelink) resource pool.

Preferably in certain embodiments, the contiguous/consecutive slots may mean contiguous physical slots.

Preferably in certain embodiments, the contiguous/consecutive slots may mean contiguous sidelink slots in/for the (sidelink) resource pool. Preferably in certain embodiments, the contiguous/consecutive slots may or may not be contiguous/consecutive in physical slots. This means that the contiguous/consecutive slots in the sidelink resource pool may be not contiguous/consecutive from the aspect of the physical slot. Preferably in certain embodiments, the contiguous/consecutive slots may or may not be contiguous/consecutive in sidelink slots in/for a sidelink Bandwidth Part (BWP) or a sidelink carrier/cell. This means that the contiguous/consecutive slots in the (sidelink) resource pool may be not contiguous/consecutive from the aspect of sidelink slots in a sidelink BWP or a sidelink carrier/cell. Preferably in certain embodiments, there may be one or more (sidelink) resource pools in a sidelink BWP or a sidelink carrier/cell.

Preferably in certain embodiments, a sub-channel is a unit for sidelink resource allocation/scheduling (for PSSCH). Preferably in certain embodiments, a sub-channel may comprise multiple contiguous PRBs in frequency domain. Preferably in certain embodiments, the number of PRBs for each sub-channel may be (pre-)configured for a sidelink resource pool. Preferably in certain embodiments, a sidelink resource pool (pre-)configuration may indicate/configure the number of PRBs for each sub-channel. Preferably in certain embodiments, the number of PRBs for each sub-channel may be any of 10, 12, 15, 20, 25, 50, 75, 100. Preferably in certain embodiments, a sub-channel may be represented as a unit for sidelink resource allocation/scheduling. Preferably in certain embodiments, a sub-channel may mean a set of consecutive PRBs in frequency domain. Preferably in certain embodiments, a sub-channel may mean a set of consecutive resource elements in frequency domain.

Preferably in certain embodiments, the first UE may have/maintain/establish multiple sidelink links/connections on PC5 interface. For different sidelink links/connections, the first UE may perform sidelink transmission/reception to/from different paired UE(s).

Preferably in certain embodiments, the UE may be/mean/comprise/replace a device.

Preferably in certain embodiments, the sidelink transmission/reception may be UE-to-UE transmission/reception. Preferably in certain embodiments, the sidelink transmission/reception may be device-to-device transmission/reception. Preferably in certain embodiments, the sidelink transmission/reception may be V2X transmission/reception. Preferably in certain embodiments, the sidelink transmission/reception may be Pedestrian-to-Everything (P2X) transmission/reception. Preferably in certain embodiments, the sidelink transmission/reception may be on PC5 interface.

Preferably in certain embodiments, the PC5 interface may be a wireless interface for communication between device and device. Preferably in certain embodiments, the PC5 interface may be a wireless interface for communication between devices. Preferably in certain embodiments, the PC5 interface may be a wireless interface for communication between UEs. Preferably in certain embodiments, the PC5 interface may be a wireless interface for V2X or P2X communication. Preferably in certain embodiments, the Uu interface may be a wireless interface for communication between network node and device. Preferably in certain embodiments, the Uu interface may be a wireless interface for communication between network node and UE.

Preferably in certain embodiments, the first UE may be a first device. Preferably in certain embodiments, the first UE may be a vehicle UE. Preferably in certain embodiments, the first UE may be a V2X UE.

Preferably in certain embodiments, the second UE may be a second device. Preferably in certain embodiments, the second UE may be a vehicle UE. Preferably in certain embodiments, the second device may be a V2X UE.

Preferably in certain embodiments, the first UE and the second device are different devices.

Preferably in certain embodiments, before transmitting in unlicensed spectrum, the TX UE performs LBT for energy detection. Preferably in certain embodiments, frequency granularity of LBT in FR1 would be 20 MHz which could be denoted as LBT band or LBT unit or RB set (in frequency domain). Preferably in certain embodiments, a carrier or SL BWP or a SL resource pool could comprise one or more LBT bands. Preferably in certain embodiments, interlace structure may be used for meeting Occupied Channel Bandwidth (OCB) and Power Spectral Density (PSD) requirements specified in unlicensed spectrum. Preferably in certain embodiments, equal space within one interlace or an equal PRB number between two adjacent PRBs within one interlace is preferred. Preferably in certain embodiments, for two adjacent interlaces, it could be PRB domain offset between each other. For example, interlace #0 would occupy PRB #0, #10, #20, . . . #90 and interlace #1 would occupy PRB #1, #11, #21, . . . #91. Preferably in certain embodiments, such interlace structure is feasible to meet requirement in unlicensed spectrum for one LBT band. However, when it comes to wideband such as a carrier/BWP/pool comprising more than one LBT band, there may be some points to be addressed. As there may be a guard band comprising one or more PRBs between adjacent LBT bands, with introduction of the guard band, interlace within each LBT band may be different. With introduction of guard band within one sidelink resource pool, a first issue is how to define a frequency unit for sub-channel in sidelink, which is a unit of sidelink operation may need further design. Signaling aspect of a wideband sidelink resource pool may need further design, that is how to indicate to the RX UE that the TX UE is using more than one LBT band for performing sidelink transmission.

A second issue is resource selection regarding how the UE (in mode-2, autonomously selecting resource based on sensing result) selects the resource for one or more TBs may need further study.

### Concept B

This concept B is to signal or indicate a number of contiguous LBT bands (which could be replaced by RB set, which is addressing same subject) in SCI. Preferably in certain embodiments, there is no need to indicate which RB set is being used for sidelink transmission via bit-map. Preferably in certain embodiments, with contiguous RB set aspect, the TX UE could signal or indicate a number of contiguous RB sets to the RX UE. Preferably in certain embodiments, the TX UE, based on LBT result, is to determine one or more RB sets which will be contiguous with each other. Preferably in certain embodiments, the TX UE would transmit SCI in the lowest sub-channel in the lowest RB set of the one or more RB sets.

Preferably in certain embodiments, the RX UE could determine a number of contiguous RB sets being used based on SCI indication. Preferably in certain embodiments, the RX UE could determine the one or more RB sets starting from which RB set is based on location of the detected SCI. Preferably in certain embodiments, for example, if the detected SCI is in RB set 1 and indication of the number of contiguous RB sets is 2, the RX UE could determine the RB set {1, 2} is occupied by the TX UE.

Preferably in certain embodiments, SCI is transmitted in one sub-channel within one LBT band. Preferably in certain embodiments, one sub-channel comprises K interlaces. Preferably in certain embodiments, for Subcarrier Spacing (SCS)=15 kHz, K=1 or 2 is based on (pre-)configuration. Preferably in certain embodiments, for SCS=30 kHz, K=1 is based on (pre-)configuration. Preferably in certain embodiments, one interlace within one RB set comprises N_PRB_i/M PRBs and preferably with ceiling or floor function, wherein N_PRB_i corresponds to the number of PRBs in RB set i and M corresponds to the number of interlaces in one RB set.

Preferably in certain embodiments, the TX UE may communicate with the RX UE in a sidelink resource pool.

Preferably in certain embodiments, the sidelink resource pool is in unlicensed spectrum.

Preferably in certain embodiments, the sidelink resource pool comprises a number of RB sets.

Preferably in certain embodiments, the sidelink resource pool comprises one or more guard bands.

Preferably in certain embodiments, the sidelink resource pool is in a SL BWP or sidelink carrier.

Preferably in certain embodiments, the SL BWP or the sidelink carrier or the sidelink resource pool may associate with the configuration of one or more guard bands.

Preferably in certain embodiments, based on the configuration of the one or more guard bands, separation of the number of RB sets is determined.

Preferably in certain embodiments, the same number or different number of PRBs or Virtual Resource Blocks (VRBs) in a different guard band.

Preferably in certain embodiments, in some examples, interlace structure is common for a sidelink resource pool or a sidelink BWP or a sidelink carrier.

Preferably in certain embodiments, considering common interlace structure among RB sets, indexing of interlace in a different RB set is associated with a common interlace index.

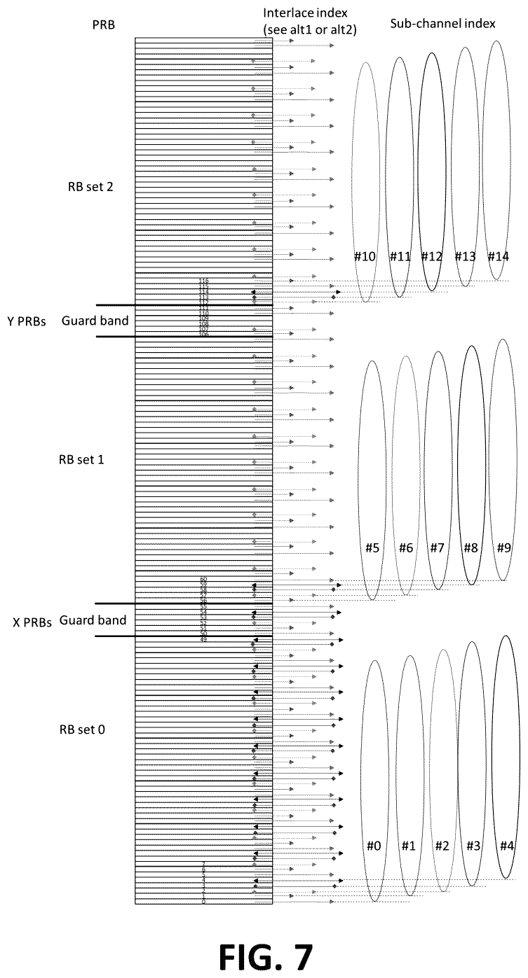

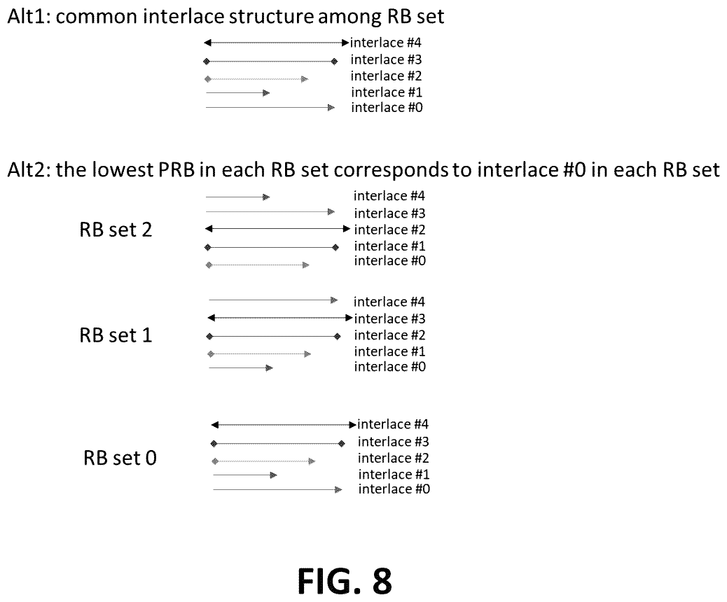

For example, as shown in FIG. 7 and a first alternative in FIG. 8, assume there are five common interlaces (e.g., common interlace #0˜#4). Interlace #0˜#4 in RB set 0 corresponds to common interlace #0˜#4. Interlace #0˜#4 in RB set 1 corresponds to common interlace #0˜#4 (i.e., interlace #0 in RB set 1 may not correspond to the lowest RB in RB set 1). Interlace #0˜#4 in RB set 2 corresponds to common interlace #0˜#4.

For example, as shown in FIG. 7 and a second alternative in FIG. 8, assume there are five common interlaces (e.g., common interlace #0˜#4). Interlace #0˜#4 in RB set 0 corresponds to common interlace #0˜#4. Interlace #0˜#4 in RB set 1 corresponds to common interlace #1˜#4, #0 (i.e., interlace #0 in RB set 1 corresponds to the lowest RB in RB set 1). Interlace #0˜#4 in RB set 2 corresponds to common interlace #2˜#4, #0, #1.

Preferably in certain embodiments, sub-channel indexing could be based on a sub-channel within an RB set then followed by increasing RB set. In one example, as shown in FIG. 5, consider a sidelink resource pool comprising 3 RB sets, and sub-channel #0˜#4 is within RB set 0 corresponding to interlace #0˜#4 in RB set 0. Preferably in certain embodiments, sub-channel #5˜#9 is within RB set 1 corresponding to interlace #0˜#4 in RB set 1 (whether interlace #0 in RB set 1 corresponds to lowest RB in RB set 1 could be determined based on the above, and this example shows interlace #0 in RB set 2 corresponds to the lowest RB in RB set 1). Preferably in certain embodiments, sub-channel #10˜#14 is within RB set 2 corresponding to interlace #0˜#4 in RB set 2 (whether interlace #0 in RB set 2 corresponds to the lowest RB in RB set 2 could be determined based on the above, and this example shows interlace #0 in RB set 2 corresponds to the lowest RB in RB set 2). Alternatively, consider sub-channel 0˜4 is reused in each RB set. Preferably in certain embodiments, sub-channel 0 in each RB set is associated with common interlace 0. Preferably in certain embodiments, sub-channel 1 in each RB set is associated with common interlace 1, and so on. In this example, the lowest sub-channel in each RB set (no matter 0 or 5 in RB set 1) may not comprise the lowest RB in each RB set.

Preferably in certain embodiments, from a signaling aspect, when SCI indicates Frequency Resource Indication Value (FRIV), SCI indicates a first number of sub-channels in one RB set which is the same as the RB set for transmitting the SCI. Preferably in certain embodiments, the FRIV is applied for one RB set. Preferably in certain embodiments, the FRIV would be associated with the same common interlace in other/another scheduled RB set. For example, if there are 2 RB sets scheduled, a first number of sub-channels is determined or indicated by SCI. There are double the first number of sub-channels scheduled by SCI due to the SCI indicating 2 RB sets.

Preferably in certain embodiments, there is an association between a sub-channel in a different RB set. Preferably in certain embodiments, the association may be determined based on the same common interlace index. Preferably in certain embodiments, for example as shown in FIG. 5, there is association between #0, #9, #13 (using common interlace denoted as long one side arrow), and association between #1, #5, #14, as they are using the same common interlace index (using common interlace denoted as short one side arrow).

Preferably in certain embodiments, the common interlace would be (pre-)configured per sidelink resource pool, SL BWP, or SL carrier or per unicast link.

Preferably in certain embodiments, as shown in FIG. 7, common interlace #0 corresponds to RB 0, 5, 10, . . . . Preferably in certain embodiments, RB in guard band between RB set 0, 1 or between RB set 1, 2 may be associated with one common interlace. Preferably in certain embodiments, whether the TX UE use RBs in the guard band is based on whether the TX UE performs successfully for two adjacent RB sets. Preferably in certain embodiments, once/when/in response to the TX UE occupying two adjacent RB sets, usage of RB in the guard band is based on common interlacing. For example, as shown in FIG. 7, when the TX UE performs successfully LBT for RB set 0 and RB set 1 (but failed to pass LBT for RB set 2), the TX UE would transmit SCI in sub-channel #1 with indication of using two RB sets. Preferably in certain embodiments, the TX UE would transmit PSSCH/Channel State Information Reference Signal (CSI-RS)/Phase Tracking Reference Signal (PT-RS) in RB 51, as shown in FIG. 7, which corresponds to common interlace #1 or which uses the same common interlace with sub-channel #1. Preferably in certain embodiments, the TX UE would transmit a TB/MAC PDU or PSSCH through sub-channel #1 (which may exclude resource for PSCCH) and sub-channel #5 (which corresponds to common interlace #1 or which uses the same common interlace with sub-channel #1). Preferably in certain embodiments, FRIV design is based on sub-channel(s) within one RB set (e.g., lowest RB set). Preferably in certain embodiments, FRIV design is based on a common interlace index. Preferably in certain embodiments, when the RX UE receives such SCI in sub-channel #1 with indication of 2 RB sets, the RX UE determines RB set #0 and RB set #1 are indicated. Preferably in certain embodiments, sub-channel in RB set 1 with the same common interlace as sub-channel in RB set 0 is indicated or scheduled by the SCI (i.e., sub-channel #5). For another example, if FRIV in SCI or resource allocation indicates 3 sub-channel (within one RB set) and indication or signaling indicates 2 RB sets in SCI detected in sub-channel #1. Based on indication of SCI, the RX UE would determine that sub-channel #1, #2, #3 and sub-channel #5, #6, #7 are used for scheduling. Preferably in certain embodiments, in one example, a sub-channel in a different RB set scheduled by SCI may correspond to a different TB transmission. Preferably in certain embodiments, in another example, a sub-channel in all different RB sets scheduled by SCI may correspond to the same TB transmission (e.g., TB is carried by all sub-channels in all scheduled RB sets). Preferably in certain embodiments, in another example, a sub-channel in a different RB set scheduled by SCI may correspond to the same TB transmission. Preferably in certain embodiments, sub-channel #1, #2, #3 corresponds to one TB, and sub-channel #5 #6 #7 corresponds to repetition of the TB. Preferably in certain embodiments, repetition of the TB could be associated with a different redundancy version. Preferably in certain embodiments, TB/MAC PDU in a sub-channel in the lowest RB set corresponds to rv=0, and TB/MAC PDU in a sub-channel in the lowest RB set corresponds to rv=2 (which is based on predefined order, e.g., rv=0, 2, 3, 1, or rv=0, 3, 0, 3, in this example, rv=0, 2, 3, 1 is used/applied).

### Concept C

This concept C is to select resource in the same RB set. For MCSt, there is one restriction and/or limitation to select one or more consecutive resource(s) being in the same or a subset of one or more RB sets as the specific candidate resource occupying when a specific candidate resource is selected. Preferably in certain embodiments, the specific candidate resource may comprise one or more sub-channels among the one or more RB sets (which is consecutive in RB set domain). Preferably in certain embodiments, the specific candidate resource may be in TTI i. Preferably in certain embodiments, when selecting a resource for MCSt in TTI i+1 in addition to TTI i, there is a restriction/limitation that the resource is selected in the same RB set(s) as the specific resource in TTI i or the resource is selected using subset RB set(s) as the specific resource in TTI i (if MCSt is enabled/used). Preferably in certain embodiments, for selecting resource for MCSt, non-strictly descending number of RB sets in the future/later TTI needs to be guaranteed. Preferably in certain embodiments, for any two consecutive TTIs (in a sidelink resource pool), resource in earlier TTI shall comprise more or an equal number of RB sets as resource in the later TTI (within a period/unit for MCSt). Preferably in certain embodiments, RB set in earlier TTI or later TTI shall be contiguous in the RB set domain. Preferably in certain embodiments, contiguous in RB set domain means or corresponds to contiguous in the RB set index. Preferably in certain embodiments, resource in TTI i and resource in TTI i+1 for MCSt may correspond to the same common interlace index (e.g., could be associated with different sub-channel index). Preferably in certain embodiments, resource in TTI i and resource in TTI i+1 for MCSt may correspond to the same sub-channel index (e.g., if sub-channel index is reused in each RB set of a sidelink resource pool).

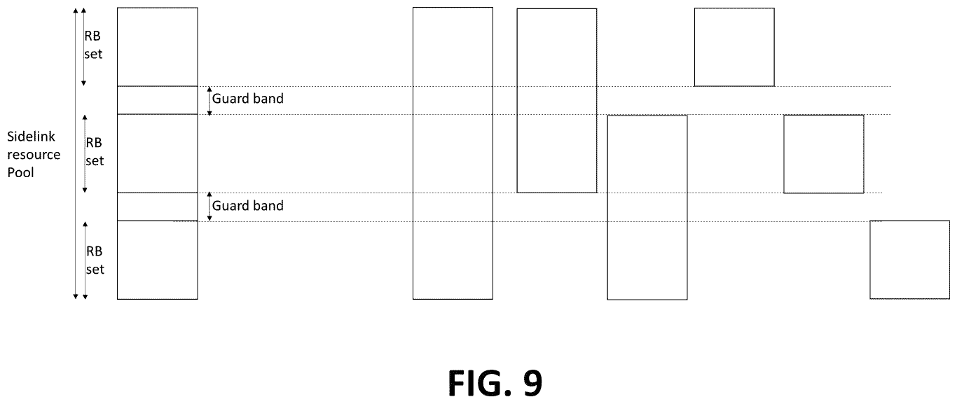

For example, as shown in FIG. 9, possible combination of RB sets for resource allocation for a sidelink resource pool comprising 3 RB sets could be illustrated. Preferably in certain embodiments, when the TX UE is enabled or supporting MCSt, the TX UE could select a first resource in 3 RB sets in TTI 1 and a second resource in 2 RB sets in TTI 2 or a third resource in 1 RB set in TTI 3. Preferably in certain embodiments, when the TX UE is enabled or supporting MCSt, the TX UE could select a first resource in 2 RB sets in TTI 1 and a second resource in 2 RB sets in TTI 2 or a third resource in 1 RB set in TTI 3. Preferably in certain embodiments, the second resource is in same 2 RB sets as the 2 RB sets for the first resource in TTI 1. Preferably in certain embodiments, the 2 RB sets is not allowed to be in different 2 RB sets as 2 RB sets for the first resource in TTI 1. Preferably in certain embodiments, in other words, once a combination/number of RB sets for the first resource in TTI 1 is determined, the combination/number of RB sets for the second resource in TTI 2 is restricted or limited to (part/subset of) the combination/number of RB sets in TTI 1. Preferably in certain embodiments, the same logic is applied for the second resource in TTI 2 and the third resource in TTI 3. Preferably in certain embodiments, in general, for MCSt with 3 TTIs considering sidelink resource pool with 3 RB sets (e.g., RB set 0, 1, 2), the combination of candidate resource occupying which RB set could be illustrated below. Preferably in certain embodiments, the aforementioned restrictions/limitations/methods/selections may or may not be applied to at least two consecutive MCSt periods/units in time domain (based on a specific configuration). If not, the number of selected RB sets in the later MCSt may be larger than the earlier MCSt and/or the index of selected RB sets in the later MCSt may be different from the earlier MCSt.

| TTI 1 | TTI 2 | TTI 3 |
|---|---|---|
| RB set 0, 1, 2 | RB set 0, 1, 2, or | RB set 0, 1, 2, or |
| | | RB set 0, 1, or |
| | | RB set 1, 2, or |
| | | RB set 0, or |
| | | RB set 1, or |
| | | RB set 2 |
| | RB set 0, 1, or | RB set 0, 1, or |
| | | RB set 0, or |
| | | RB set 1 |
| | RB set 1, 2, or | RB set 1, 2, or |
| | | RB set 1, or |
| | | RB set 2 |
| | RB set 0, or | RB set 0 |
| | RB set 1, or | RB set 1 |
| | RB set 2 | RB set 2 |
| RB set 0, 1 | RB set 0, 1, or | RB set 0, 1, or |
| | | RB set 0, or |
| | | RB set 1 |
| | RB set 0, or | RB set 0 |
| | RB set 1 | RB set 1 |
| RB set 1, 2 | RB set 1, 2, or | RB set 1, 2, or |
| | | RB set 1, or |
| | | RB set 2 |
| | RB set 1, or | RB set 1 |
| | RB set 2 | RB set 2 |
| RB set 0 | RB set 0 | RB set 0 |
| RB set 1 | RB set 1 | RB set 1 |
| RB set 2 | RB set 2 | RB set 2 |

Alternatively and/or preferably in certain embodiments, when the TX UE packages or groups one or more resources in one or more consecutive TTIs as one MCSt unit in time domain, the one or more resources shall be in the same RB set or a subset of RB sets than the earlier TTI. Preferably in certain embodiments, when the TX UE packages or groups one or more resources in one or more consecutive TTIs as one MCSt unit in time domain, the one or more resources in each TTI in the MCSt unit shall follow the above lesson of 3 TTIs.

Preferably in certain embodiments, RBs 0, 5, 10, 5i, . . . correspond to common interlace index 0 (e.g., long arrow in FIG. 7).

Preferably in certain embodiments, RBs 1, 6, 11, 5i+1, . . . correspond to common interlace index 1 (e.g., short arrow in FIG. 7).

Preferably in certain embodiments, RBs 2, 7, 12, 5i+2, . . . correspond to common interlace index 2 (e.g., diamond arrow in FIG. 7).

Preferably in certain embodiments, RBs 3, 8, 13, 5i+3, . . . correspond to common interlace index 3 (e.g., bi-diamond in FIG. 7).

Preferably in certain embodiments, RBs 4, 9, 14, 5i+4, . . . correspond to common interlace index 4 (e.g., bi-arrow in FIG. 7).

### Concept D

This concept D is to design the definition of candidate resource within a selection window for mode-2 resource identification and resource selection. Preferably in certain embodiments, the higher layer of the TX UE would provide a number of sub-channels (e.g., L) for resource identification and selection. Preferably in certain embodiments, one candidate resource in legacy NR Rel-16 SL is one slot and one starting sub-channel Preferably in certain embodiments, the candidate resource (defined in unlicensed spectrum) would be different. Preferably in certain embodiments, consider a sidelink resource pool comprising M*N sub-channels, wherein M corresponds to a number of interlaces and/or a number of sub-channels in one RB set, and N corresponds to a number of RB sets associated with the sidelink resource pool.

Preferably in certain embodiments, when counting how many candidate resources are in a slot in the sidelink resource pool, some operation with exclusion and/or inclusion would be applied. Preferably in certain embodiments, when counting how many total candidate resources are in a resource selection window in the sidelink resource pool, some operation with exclusion and/or inclusion would be applied. Preferably in certain embodiments, the resource selection window may comprise more than one slot in the sidelink resource pool.

Preferably in certain embodiments, the exclusion and/or inclusion is based on the sidelink resource pool being configured in unlicensed spectrum (e.g., with type-1/2/2A/2B/2C channel access before performing transmission). Preferably in certain embodiments, for the pool being configured in licensed spectrum (e.g., without type-1/2/2A/2B/2C channel access before performing transmission), the exclusion and/or inclusion (when counting how many candidate resource in a slot) is not applied.

Preferably in certain embodiments, the TX UE would determine or identify X % of total number of candidate resources in a selection window.

Preferably in certain embodiments, the determining or identifying X % of total number of candidate resources could be based on excluding one or more resources resulting half-duplex and/or occupied by another/other UE (based on sensing result).

Preferably in certain embodiments, if the total number of candidate resources in a selection window comprises a specific candidate resource, which comprises a sub-channel in a different RB set, without equal space in frequency domain, the TX UE would exclude the specific candidate resource (when determining or identifying X % of total number of candidate resources in a selection window).

Preferably in certain embodiments, X is configured per priority.

Preferably in certain embodiments, X=20.

Preferably in certain embodiments, the lower layer (e.g., Physical (PHY) layer) of the TX UE would report X % of total number of candidate resources to the higher layer (e.g., MAC layer) of the TX UE for resource selection.

Preferably in certain embodiments, the higher layer of the TX UE would randomly select one or more candidate resources for one or more TB's transmission.

Preferably in certain embodiments, sub-channel #9 or sub-channel #0 in RB set 1 could be replaced by one specific sub-channel in RB set 1, wherein the one specific sub-channel comprises the same common interlace index as sub-channel #0 in RB set 0. Preferably in certain embodiments, a first specific sub-channel comprises K interlaces in a first RB set (e.g., K=1, 2, and with contiguous interlace index). Preferably in certain embodiments, a second specific sub-channel comprises the same number of K interlaces in a second RB set (e.g., K=1, 2, and with contiguous interlace index). Preferably in certain embodiments, a candidate resource comprising a sub-channel in a different RB set may be based on the same common interlace index. Preferably in certain embodiments, a sub-channel in a different RB set being associated with a candidate resource is based on the same common interlace index of sub-channel in different RB set. Preferably in certain embodiments, a sub-channel in a different RB set associated with a different common interlace cannot associate with a candidate resource or this is not a valid/available sub-channel combination for a resource.

Preferably in certain embodiments, which RB in the guard band is associated with which sub-channel is based on the same common interlace index.

For example, as shown in FIG. 7, assume the TX UE transmits SCI in sub-channel 5, with indication of using sub-channel 5, 6, 10, 14. Preferably in certain embodiments, the TX UE could use Y RBs in the guard band. Preferably in certain embodiments, based on common interlace, RB 106 and 111 are as the same common interlace structure/index as sub-channel 5 and sub-channel 14. Preferably in certain embodiments, RB 107 is as the same common interlace structure/index as sub-channel 6 and sub-channel 10. Preferably in certain embodiments, RB 106 is associated with sub-channel 5. Preferably in certain embodiments, RB 111 is associated with sub-channel 14.

Preferably in certain embodiments, one slot could be replaced by TTI.

Preferably in certain embodiments, one TTI could be more than one consecutive slot (in a sidelink resource pool).

Preferably in certain embodiments, when the TX UE transmits sidelink using each candidate resource in one TTI, the starting symbol of each candidate resource in different TTI may be different. Preferably in certain embodiments, it may depend on the LBT result and the location of the additional starting symbol of each TTI.

Preferably in certain embodiments, a candidate resource comprises a first number of (contiguous) sub-channels in a first RB set and a second number of (contiguous) sub-channels in a second RB set.

Preferably in certain embodiments, the first RB set and the second RB set are in a sidelink resource pool.

Preferably in certain embodiments, the first RB set is with the RB set index which is contiguous to the RB set index of the second RB set.

Preferably in certain embodiments, the first number of (contiguous) sub-channels is the same or could be different than the second number of (contiguous) sub-channels.

Preferably in certain embodiments, a different sidelink resource pool in the same SL BWP or SL carrier may share the same interlace structure.

Alternatively, a different sidelink resource pool in the same SL BWP or SL carrier may be configured with a different interlace structure. For example, sub-channel indexing in a different sidelink resource pool could be configured with or comprise a different number of interlaces. For example, one/each sub-channel in a first sidelink resource pool in a SL BWP comprises one interlace while one/each sub-channel in a second sidelink resource pool in the SL BWP comprises two interlaces.

Preferably in certain embodiments, the first sidelink resource pool is configured in the same SL BWP as the second sidelink resource pool. Preferably in certain embodiments, there is one Subcarrier Spacing (SCS) associated with SL BWP. Preferably in certain embodiments, one restriction or limitation is used for the SL BWP that the sub-channel in the first sidelink resource pool or in the second sidelink resource pool comprises the same number of interlaces (once/when/if the first sidelink resource pool and the second sidelink resource pool are in the same SL BWP).

Preferably in certain embodiments, in some examples, the first sidelink resource pool is configured in a different SL BWP or SL carrier than the second sidelink resource pool.

Preferably in certain embodiments, there may be some condition for the TX UE to use the candidate resource comprising the sub-channel in different RB sets. Preferably in certain embodiments, any one or any combination condition could be:
CBR>threshold.
Total number of candidate resources without counting candidate resources with different RB set <thresholds.
A number of times of increasing 3 dB RSRP>threshold (e.g., 3).
Selecting candidate resource for retransmission (other than new transmission).
L (candidate resource length or contiguous number of sub-channels) is larger than M (a number of interlace).
L (candidate resource length or contiguous number of sub-channels) is larger than a threshold.

Preferably in certain embodiments, when L is smaller than a threshold (e.g., the threshold could be preconfigured or fixed or being determined as same as value of number of interlace, M), the candidate resource comprising the sub-channel in different RB sets is not used or disabled and/or the TX UE is not allowed to or does not select/identify the candidate resource comprising the sub-channel in different RB sets. Preferably in certain embodiments, when L is larger than or equal to the threshold, the candidate resource comprising the sub-channel in different RB sets could be used or enabled and/or the TX UE is allowed to or could select/identify the candidate resource comprising the sub-channel in different RB sets. Preferably in certain embodiments, in some examples, the candidate resource comprising the sub-channel in different RB sets is associated with the same common interlace index. Preferably in certain embodiments, in some examples, the candidate resource comprising the sub-channel in different RB sets is associated with the same sub-channel index in different RB sets. For example, FRIV in SCI indicates sub-channel 0˜3 and 2 RB sets and the SCI is detected in RB set 1, sub-channel 0˜3 in both RB set 1 and 2 are used.

Preferably in certain embodiments, the RB in the guard band may associate with the sub-channel in the lower adjacent RB set starting from lowest sub-channel plus one. For example, as shown in FIG. 5, assuming there are sub-channels 0-4 in each RB set (rather than defining sub-channel 5˜14). Preferably in certain embodiments, sub-channel 0 in each RB set corresponds to the one comprising the lowest RB in the respective RB set.

Preferably in certain embodiments, when the TX UE passes LBT for transmitting on sub-channel 1 2 3 in both RB set 0 and RB set 1,
RB 50˜55 in the guard band could be associated with sub-channel 2, 3, 2, 3, 2, 3 in RB set 0.
RB 50˜55 in the guard band could be associated with sub-channel 2, 3 in RB set 0 and 1, 2, 3 in RB set 1.

Preferably in certain embodiments, the RB in the guard band is the last RB in the associated sub-channel.

Preferably in certain embodiments, the higher layer of the TX UE could select a first candidate resource in a first slot and a second candidate resource in a second slot. Preferably in certain embodiments, the first and the second slot could be a same slot. Preferably in certain embodiments, the first slot and the second slot could be a different slot. Preferably in certain embodiments, the first candidate resource and the second candidate resource are used for a TB transmission. Preferably in certain embodiments, the first candidate resource is associated with a first RB set. Preferably in certain embodiments, the second candidate resource is associated with a second RB set. Preferably in certain embodiments, in response to the same slot of the first slot and the second slot, the TX UE would, based on the LBT result for each RB set, to determine whether to. Preferably in certain embodiments, the first candidate resource may comprise with a different starting sub-channel than the starting sub-channel associated with the second candidate resource. Preferably in certain embodiments, the space between the interlace associated with the sub-channel or the sub-channel associated with the first candidate resource may be unequal compared to the interlace associated with the sub-channel or the sub-channel associated with the second candidate resource. Preferably in certain embodiments, each candidate resource (no matter from RB set) is with the same contiguous number of sub-channels (e.g., L). Preferably in certain embodiments, the respective set/number of candidate resources for each RB set comprises candidate resource(s) with the same contiguous number of sub-channels (e.g., L). Preferably in certain embodiments, the candidate resource in each set of candidate resources associated with the respective RB set is in the respective RB set.

Preferably in certain embodiments, when/if the TX UE simultaneously pass LBT for the first RB set and the second RB set (or said pass LBT for more than one RB set), the TX UE would perform sidelink transmission on the first candidate resource (which is within the lower RB set). Preferably in certain embodiments, when/if the TX UE simultaneously pass LBT for the first RB set and the second RB set (or said pass LBT for more than one RB set), the TX UE would perform sidelink transmission on the second candidate resource (which is within higher RB set). Preferably in certain embodiments, when/if the TX UE simultaneously pass LBT for the first RB set and the second RB set (or said pass LBT for more than one RB set), the TX UE may select one based on another/other condition such as CBR. Preferably in certain embodiments, the TX UE could perform sidelink transmission on both the first and the second candidate resource (when/if the TX UE supports this capability). Preferably in certain embodiments, RB in the guard band between the first and the second RB set could be used. Preferably in certain embodiments, which RB in the guard band to be used is based on indication of SCI.

Preferably in certain embodiments, the TX UE could be configured with whether to perform inclusion of candidate resource comprising a sub-channel in a different RB set (e.g., cross-RB set) or supporting cross-RB set transmission.

Preferably in certain embodiments, the candidate resource comprises a sub-channel in a different RB set associated with the same common interlace index.

Preferably in certain embodiments, based on a sidelink resource pool comprising more than one RB set, the TX UE could be configured with whether to perform inclusion of candidate resource comprising a sub-channel in a different RB set (e.g., cross-RB set) or supporting cross-RB set transmission.

Preferably in certain embodiments, based on a sidelink resource pool comprising more than one RB set and interlace structure for sidelink transmission in the sidelink resource pool, the TX UE could be configured with whether to perform exclusion of a candidate resource comprising a sub-channel in a different RB set (e.g., cross-RB set) or supporting cross-RB set transmission.

Preferably in certain embodiments, based on a sidelink resource pool comprising more than one RB set and interlace structure for sidelink transmission in the sidelink resource pool, the TX UE could be configured with whether to perform inclusion of a candidate resource comprising a sub-channel in a different RB set (e.g., cross-RB set) or supporting cross-RB set transmission.

Preferably in certain embodiments, for a sidelink resource pool being configured with supporting or enabling cross-RB set transmission (e.g., using a sidelink resource comprising sub-channel in different RB set), all UEs performing sidelink transmission using the sidelink resource pool would support or enable cross-RB set transmission.

Preferably in certain embodiments, for a candidate resource comprising a sub-channel in a different RB set, the number of the sub-channel of the candidate resource in the different RB set will be the same. Preferably in certain embodiments, in one example, there is no candidate resource with 1 sub-channel in RB set 0 and 2 sub-channels in RB set 1, or vice versa. Preferably in certain embodiments, there are some restrictions of L. Preferably in certain embodiments, for L≤M, L could be any number. Preferably in certain embodiments, for L>M, L is restricted to be multiple integer numbers of at least one of the following number 2, 3, . . . N, wherein N is the number of RB sets in a sidelink resource pool. Preferably in certain embodiments, the rationale is to have/be equally divided into at least one of said number. For example, as shown in FIG. 7, if L=7 is larger than M=5, 7 is not divisible by 2 nor N=3, L=7 is not possible to be configured by a higher layer. Preferably in certain embodiments, as shown in FIG. 7, the possible L value shall be 1, 2, 3, 4, 5, 6, 8, 9, 10, 12, 14, 15.

Preferably in certain embodiments, the SCI is transmitted in the lowest sub-channel of the lowest RB set of the candidate resource.

Preferably in certain embodiments, when the SCI indicates or signals a candidate resource comprising a sub-channel in a different RB set, the SCI could indicate or signal FRIV in one RB set (which is the lowest RB set in a sidelink resource pool or the lowest RB set of the candidate resource). Preferably in certain embodiments, the SCI would indicate a contiguous number of RB sets being more than 1 (as illustrated in concept B).

Preferably in certain embodiments, when the SCI indicates or signals a candidate resource comprising a sub-channel in the same RB set, the SCI could indicate or signal FRIV in one RB set (which is the lowest RB set in a sidelink resource pool or the lowest RB set of the candidate resource). Preferably in certain embodiments, the SCI would indicate a number of a contiguous RB set being 1 (as illustrated in concept B).

Preferably in certain embodiments, FRIV is based on a sub-channel in one RB set.

Preferably in certain embodiments, the code-point 0 of FRIV corresponds to the lowest sub-channel index in one RB set.

For example, as shown in FIG. 7, the size of the field for FRIV would be log₂(M*(M+1)/2). Preferably in certain embodiments, when the SCI is detected in a sub-channel #5 with FRIV={0, 1}. Based on the detected location of the sub-channel, FRIV would be interpreted as sub-channel #5 and sub-channel #6. Based on a number of contiguous RB sets as 1, indication of the SCI is sub-channel #5 and sub-channel #6, and/or resource scheduled by the SCI corresponds to 2 sub-channels. Based on a number of contiguous RB sets as 2, indication of the SCI is sub-channel #5, sub-channel #6, sub-channel #10, and sub-channel #14 and/or the resource scheduled by the SCI corresponds to 4 sub-channels. Preferably in certain embodiments, resource allocation is at least based on a detected location of a sub-channel of the SCI. Preferably in certain embodiments, when the SCI is detected rather than the lowest RB set (e.g., RB set 0), FRIV would be translated into one or more sub-channels in the RB set where the SCI is detected (e.g., FRIV is for sub-channel #0, #1, which is interpreted/translated into sub-channel #5, #6, if the SCI is detected in #5 in RB set 1, or which is interpreted/translated into sub-channel #10, #11, if the SCI is detected in #10n RB set 2). Preferably in certain embodiments, a number of sub-channels for PSSCH is (determined) based on FRIV and a number of contiguous RB sets (indicated by SCI).

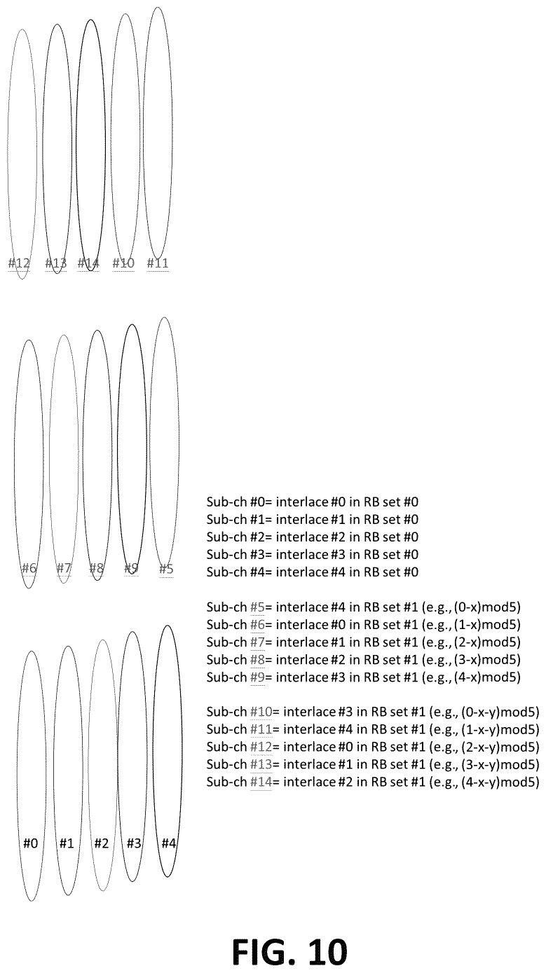

Preferably in certain embodiments, association between the interlace and the sub-channel could be illustrated in FIG. 10. Preferably in certain embodiments, common interlace 0 is associated with the lowest sub-channel in each RB set. Preferably in certain embodiments, common interlace 1 is associated with the second lowest sub-channel in each RB set, and so on. Preferably in certain embodiments, sub-channel #5 in the RB set is the sub-channel comprising common interlace 0. Alternatively, consider sub-channel 0˜4 is reused in each RB set. Preferably in certain embodiments, sub-channel 0 in each RB set is associated with common interlace 0. Preferably in certain embodiments, sub-channel 1 in each RB set is associated with common interlace 1, and so on. In this example, the lowest sub-channel in each RB set (no matter 0 or 5 in RB set 1) may not comprise the lowest RB in each RB set.

### Concept E

This concept E is that when performing resource (re)selection for transmitting one or more MAC PDUs in a set of SL resources, a UE could select/set a number of retransmissions (for a MAC PDU) based on at least a number of reservation interval (in unit of slots or ms). For example, the UE could select/set the number of retransmissions the same as the number of reservation interval. For another example, the UE could select the number of retransmission (in unit of times) as the number of reservation interval −1.

The set of SL resources could be for multi-consecutive slot transmission. The set of SL resources could be consecutive in time domain. For example, there may not be time gap between nearby/neighboring resources in the set of SL resources.

The resource (re)selection could be performed to select a set of SL resource(s). Each SL resource in the set of SL resource(s) could be used to perform new transmission of SL data or MAC CEs or retransmission of (the previously generated/transmitted) SL data and/or MAC CEs. When or if the UE operates in SL unlicensed spectrum and/or selects SL resource pool in SL unlicensed spectrum for SL transmission, the UE could be expected to select consecutive SL resource(s) (e.g., continuous and not having gaps between SL resources in time domain).

Additionally and/or alternatively, for selecting consecutive resources, the UE could be configured (by a network or pre-configured or by other UEs) with a configuration or parameter indicating the UE to select consecutive resources. For example, a UE could be configured with MCSt behavior, feature, or functionality for a SL resource pool or for a PC5 link or a sidelink connection. Additionally and/or alternatively, the UE could determine to select consecutive resources based on whether the UE operates on or selects resources in unlicensed spectrum.

The reservation interval could be a value selected by the UE. The reservation interval could be configured/provided by a network (e.g., via Radio Resource Control (RRC) dedicated message or system information) or pre-configured in the UE. For example, the reservation interval could be a value configured in a candidate list of reservation intervals (e.g., sl-ResourceReservePeriodList).

Additionally and/or alternatively, Network (NW) configuration to the UE on SL resource parameters (e.g., candidate list of reservation interval and/or maximum number of (Hybrid Automatic Repeat Request (HARQ) transmissions) could be expected to ensure new transmission and retransmission are consecutive. For example, the NW could be expected to (always) configure value 1 and/or value 0 in the candidate list of reservation interval.

Additionally and/or alternatively, if MCSt is configured or enabled for the UE (in a SL resource pool or on SL unlicensed spectrum), the UE could be expected to select consecutive resources for new transmission and/or retransmission of one or more MAC PDUs.

Alternatively, if or when the UE performs resource (re)selection in SL unlicensed spectrum, the UE may not take CBR measurement and/or priority of SL data into consideration when selecting the number of retransmissions. The UE may not be expected to select a set of SL resources with time gaps separating each resource (when the set of SL resources are associated with SL resource pool(s) in SL unlicensed spectrum).

Additionally and/or alternatively, the UE could select/set the number of HARQ (re)transmissions for transmissions of MAC PDUs on SL unlicensed spectrum. The UE could select/set the reservation interval based on the number of HARQ retransmissions. For example, The UE could set the value of reservation interval (in unit of ms or slot) for SL transmissions of MAC PDUs the same as the number of HARQ retransmissions, or the number of HARQ retransmissions +1.

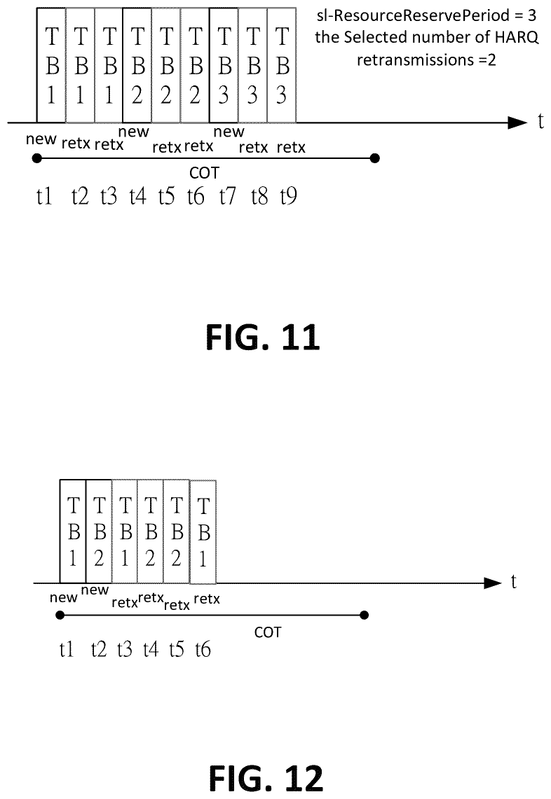

An example is shown in FIG. 11. A UE could be configured with MCSt operation and/or operates/selects resources in a SL resource pool in channel occupancy time in a SL unlicensed spectrum. The UE could determine or decide to select a set of SL resources for transmission of multiple MAC PUDs or TBs. The UE could select a value for the reservation interval. The UE could be (pre-)configured with a list of possible reservation intervals (e.g., sl-ResourceReservePeriodList). The UE could select a value in the list of possible reservation intervals for the reservation interval (e.g., select sl-ResourceReservePeriod=3). The UE could select the number of HARQ retransmissions based on at least the reservation period. For example, the UE could set or select/derive the number of HARQ retransmissions to 2 (or select the number of HARQ transmission to 3). When selecting time and frequency resources for the set of SL resources, the UE could select a first subset of resources at timing t1, t4, and t7. The UE could select a second subset of resources at timing t2, t5, and t8. The UE could select a third subset of resources at timing t3, t6, and t9. Each resource in the subset of resources is spaced out by the reservation interval selected in time domain. The UE could consider the first subset of resources to be new transmission opportunities for SL MAC PDU transmissions (based on the resources being before the second and the third subset of resources in time domain). The UE could consider the first subset of resources to be retransmission opportunities. The combination of the first, second, third subsets of resources (e.g., the selected set of SL resources) could be consecutive in time domain. The selected set of SL resources may not exceed the COT.

Additionally and/or alternatively, the network could configure two candidate lists of reservation intervals. For example, the network could configure a first candidate list for licensed spectrum, and a second candidate list for unlicensed spectrum. When selecting reservation intervals, the UE could determine whether to select from the first candidate list or the second candidate list based on a selected resource pool being associated with licensed or unlicensed spectrum.

Additionally and/or alternatively, the network could configure two maximum number of HARQ transmissions. For example, the network could configure a first maximum number for licensed spectrum, and a second maximum number for unlicensed spectrum.

Additionally and/or alternatively, the network could configure a fixed number (e.g., instead of a candidate list) for the reservation interval for SL unlicensed spectrum. Additionally and/or alternatively, the network could configure a fixed number (e.g., instead of a candidate list) for number of HARQ transmissions for SL unlicensed spectrum.

Additionally and/or alternatively, for selecting a set of SL resources (in a SL resource pool) in SL unlicensed spectrum, the UE could select a set of consecutive resources by setting the reservation interval as 1. The UE may not select or set the number of retransmissions. Additionally and/or alternatively, the UE could select a set of consecutive resources with the number of resources smaller than a derived/selected value (e.g., SL_RESOURCE_RESELECTION_COUNTER). The derived/selected value could be the number of (individual) MAC PDUs to be transmitted in the set of SL resources. Alternatively, the number of resources can be larger than the SL_RESOURCE_RESELECTION_COUNTER. For example, the number of resources can be a multiple of SL_RESOURCE_RESELECTION_COUNTER (e.g., SL_RESOURCE_RESELECTION_COUNTER times the number of HARQ transmissions). Alternatively, the number of resources can be equal to (or smaller than) the number of resources, can be selected for the set of SL resources in COT. Alternatively, the UE could select at least one SL resource for each timing (e.g., each ms or each slot) in COT. For each of the resources in the set of SL resources, the UE could determine whether the resource is for new transmission or for retransmission. The UE could assign or deploy its SL HARQ process to each of the resources for either a new transmission of a MAC PDU or a retransmission of a (already transmitted or generated) MAC PDU.

An example is shown in FIG. 12. For resource selection for a set of SL resources in a SL resource pool in SL unlicensed spectrum, the UE could select a number of consecutive SL resources. The UE could select resources available during COT. The UE could select or set the number of reservation interval to 1. The UE could select a number for number of HARQ transmissions (e.g., 3). The UE could derive a value for the number of (individual or different) MAC PDUs to be transmitted in the set of SL resources (e.g., 2 in FIG. 12). The UE could determine or decide the number of resources to be selected for the set of SL resources based on the number of HARQ transmissions and the number of MAC PDUs to be transmitted (e.g., 3 times 2 equals 6). Alternatively, the UE may not consider the number of reservation intervals nor the number of HARQ transmissions when selecting resources in unlicensed spectrum. The UE selects 6 resources (in timing t1 to t6) with timing in COT. The UE could determine or decide whether each resource in the set of resources is for a new transmission or for a retransmission (based on data priority, latency, QoS, or higher layer configuration). For example, resource at timing t1 is for a new transmission of MAC PDU, TB1. Resource at timing t2 is for a new transmission of MAC PDU, TB2. The resources at t3 to t6 are for retransmission of the TB1 and/or TB2.

Additionally and/or alternatively, the set of SL resources could be segmented or separated between transmissions of different MAC PDUs. For example, for transmissions of a MAC PDU, there could be a bundle of transmissions (new transmission and one or more retransmissions; or one or more retransmissions).

A configuration or parameter could be (pre-)configured for the UE to indicate whether transmission resources of a MAC PDU should be selected/set consecutively in time domain. For example, if the parameter for consecutive transmission is configured or enabled, the UE could select retransmission resources (only) from available resources that are consecutive, in time domain, with new transmission of the MAC PDU. If the parameter for consecutive transmission is not configured or disabled, the UE could select retransmission resources from any available resources that may or may not be consecutive, in time domain, with new transmission of the MAC PDU.

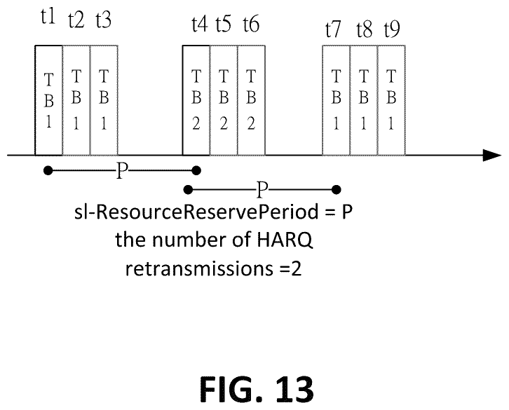

An example is shown in FIG. 13. The UE could determine or decide to select a set of SL resources for transmission of multiple MAC PDUs. The UE selects the number of reservation interval as P. The UE could be configured with (enabling) consecutive transmissions for a (bundle of transmissions for a) MAC PDU or TB. The UE could select the number of HARQ transmissions (e.g., 3). The number of HARQ retransmissions could be selected/derived (e.g., 2). The UE could determine or select initial transmission resources spaced out by reservation interval P. The UE could select consecutive retransmission resources for each of the initial transmission resources (e.g., t1, t2, and t3 are continuous in time domain; t4, t5, and t6 are continuous in time domain; t7, t8, and t9 are continuous in time domain).

An initial transmission resource could be used to transmit a new transmission of a TB or a first transmission instance/opportunity of a bundle of retransmissions.

Additionally and/or alternatively, a UE could be configured with MCSt configuration for each of the SL Logical Channels (LCHs). Each of the SL LCHs could be configured with MCSt configuration. Each of the SL LCHs could be (individually) configured with enabling or disabling. Each SL LCH could be associated with a priority. Each SL LCH could be associated with SL data with a priority or with a SL service.

When selecting SL resources, the UE could, based on the configuration of a SL LCH with highest priority among SL LCHs with at least SL data available, determine whether to select consecutive resources in time domain for MAC PDUs.

Additionally and/or alternatively, the network could configure a third candidate list for reservation intervals for transmitting SL data (associated with MCSt enabled SL LCH) with MCSt. The network could configure a fourth candidate list for reservation intervals for transmitting SL data that does not require or is not associated with MCSt. Additionally and/or alternatively, the network could configure a third maximum number of transmissions for transmitting SL data (associated with MCSt enabled SL LCH) with MCSt. The network could configure a fourth maximum number of transmissions for transmitting SL data that does not require or is not associated with MCSt.

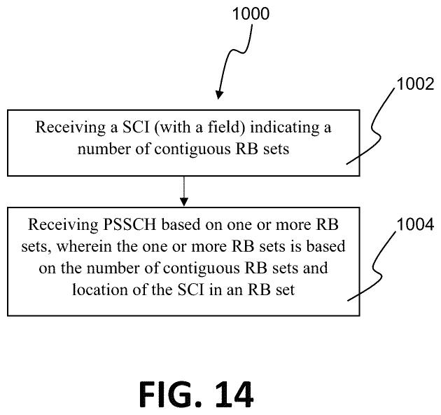

Referring to FIG. 14, with this and other concepts, systems, and methods of the present invention, a method 1000 for a first UE comprises receiving a SCI (with a field) indicating a number of contiguous RB sets (step 1002), and receiving PSSCH based on one or more RB sets, wherein the one or more RB sets is based on the number of contiguous RB sets and location of the SCI in an RB set (step 1004).

Preferably in certain embodiments, the SCI is transmitted from a second UE.

Preferably in certain embodiments, the SCI is transmitted in a sidelink resource pool.

Preferably in certain embodiments, the sidelink resource pool comprises a first number of RB sets, wherein the first number of RB sets could be 1, 2, 3, 4, or 5.

Preferably in certain embodiments, a first number of RB sets associated with a sidelink resource pool is based on how many guard bands are included in the sidelink resource pool.

Preferably in certain embodiments, the first number of RB sets is determined based on the number of guard bands.

Preferably in certain embodiments, the first number of RB sets is the number of guard bands plus one.

Preferably in certain embodiments, FRIV is based on one RB set and preferably could be the lowest RB set in the sidelink resource pool.

Preferably in certain embodiments, the sidelink resource pool is associated with one common interlace structure.

Preferably in certain embodiments, the sub-channel in each RB set comprises the lowest RB index is sub-channel index 0.

Preferably in certain embodiments, the sub-channel in each RB set comprises the same interlace index 0 (and 1) as the sub-channel in the lowest RB set is sub-channel index 0.

Preferably in certain embodiments, the sub-channel in the different RB set would be indexed differently.

Preferably in certain embodiments, when the number of contiguous RB sets indicated by (the field in) the SCI is more than one, the number of sub-channels in each RB set of the one or more RB set is the same.

Preferably in certain embodiments, the number of the sub-channel in each RB set is L, wherein L is indicated by FRIV or SCI, and/or the number of the sub-channel for PSSCH reception is (based on) the number of contiguous RB sets and L.

Preferably in certain embodiments, when FRIV indicates sub-channel 1, 2 in RB set i and the number of contiguous RB sets is K, the first UE receives PSSCH in RB sets i, i+1, i+K−1

Preferably in certain embodiments, the number of contiguous RB sets (e.g., K) with the location of the RB set for detected SCI (e.g., RB set i) cannot exceed or is not allowed to exceed the RB set in the sidelink resource pool, and/or i+K−1 is smaller than or equal to N−1 (there are N RB sets in a sidelink resource pool, denoted as 0˜N−1).

Preferably in certain embodiments, L sub-channels in each RB set of K RB sets is associated with the same common interlace index.

Preferably in certain embodiments, L sub-channels based on FRIV are duplicated or copied into K RB sets.

Preferably in certain embodiments, the RB in the guard band is associated with sub-channel(s) in the RB set other than the lowest sub-channel (according to FRIV).

Preferably in certain embodiments, the SCI is received in one sub-channel in RB set i, and the one sub-channel is used to determine starting sub-channel for FRIV or L sub-channels in one RB set.

Preferably in certain embodiments, sub-channel(s) used for PSSCH reception in RB set other than RB set i is based on the same sub-channel index in the RB set used in RB set i.

Preferably in certain embodiments, sub-channel(s) used for PSSCH reception in the RB set other than RB set i is based on the sub-channel index in the RB set with same interlace index(s) as sub-channel(s) used/associated in RB set i.

Referring back to FIGS. 3 and 4, in one or more embodiments from the perspective of a first device, the device 300 includes a program code 312 stored in memory 310 of the transmitter. The CPU 308 could execute program code 312 to: (i) receive a SCI (with a field) indicating a number of contiguous RB sets; and (ii) receive PSSCH based on one or more RB sets, wherein the one or more RB sets is based on the number of contiguous RB sets and location of the SCI in an RB set. Moreover, the CPU 308 can execute the program code 312 to perform all of the described actions, steps, and methods described above, below, or otherwise herein.

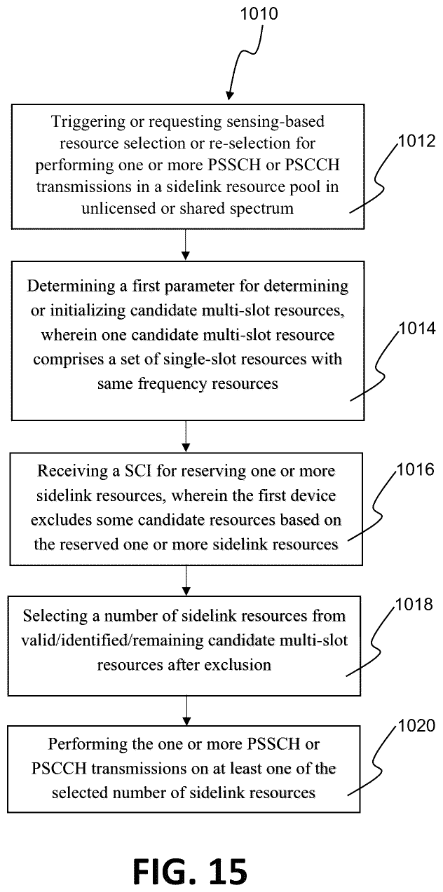

Referring to FIG. 15, with this and other concepts, systems, and methods of the present invention, a method 1010 for a first device comprises triggering or requesting sensing-based resource selection or re-selection for performing one or more PSSCH or PSCCH transmissions in a sidelink resource pool in unlicensed or shared spectrum (step 1012), determining a first parameter for determining or initializing candidate multi-slot resources, wherein one candidate multi-slot resource comprises a set of single-slot resources with same frequency resources (step 1014), receiving a SCI for reserving one or more sidelink resources, wherein the first device excludes some candidate resources based on the reserved one or more sidelink resources (step 1016), selecting a number of sidelink resources from valid/identified/remaining candidate multi-slot resources after exclusion (step 1018), and performing the one or more PSSCH or PSCCH transmissions on at least one of the selected number of sidelink resources (step 1020).

Preferably in certain embodiments, the set of single-slot resources for the one candidate multi-slot resource are with a same starting sub-channel, a same number of sub-channels, a same starting RB set, and a same number of RB sets. Preferably in certain embodiments, the set of single-slot resources for the one candidate multi-slot resource are within same RB set(s) and with a same starting sub-channel and a same number of sub-channels.

Preferably in certain embodiments, the first parameter is configured in a configuration of the sidelink resource pool, or the first parameter is determined or derived based on a priority and/or a remaining PDB associated with sidelink data of the one or more PSSCH or PSCCH transmissions, or the first parameter is determined or derived based on a CAPC associated with sidelink data of the one or more PSSCH or PSCCH transmissions, or the first parameter is determined or derived based on a (time length of) COT duration, or the first parameter is determined or derived based on a CBR of the sidelink resource pool.

Preferably in certain embodiments, the first device excludes the some candidate resources based on the reserved one or more sidelink resources comprises the first device excluding any candidate multi-slot resources which at least partially overlaps with the reserved one or more sidelink resources.

Preferably in certain embodiments, the first device determines or initializes candidate single-slot resources, and/or the first device excludes any candidate single-slot resources which at least partially overlaps with the reserved one or more sidelink resources, and/or the first device determines or derives valid/identified/remaining candidate single-slot resources after performing the exclusion, and/or the first device determines or initializes the candidate multi-slot resources, based on the first parameter, from the valid/identified/remaining candidate single-slot resources.

Preferably in certain embodiments, when the first parameter is larger than one, the first devices determines or initializes the candidate multi-slot resources for performing the triggered or requested sensing-based resource selection or re-selection, and/or when the first parameter is one, the first devices determines or initializes candidate single-slot resources for performing the triggered or requested sensing-based resource selection or re-selection.

Preferably in certain embodiments, the valid/identified/remaining candidate multi-slot resources are in a same one or more RB sets in the sidelink resource pool.

Preferably in certain embodiments, the sidelink resource pool comprises one or more RB sets, and/or the triggered or requested sensing-based resource selection or re-selection are performed on part of the one or more of RB sets in the sidelink resource pool, and/or the first device checks or ensures that the number of the valid/identified/remaining candidate multi-slot resources is larger than or equal to X·Mₜₒₜₐₗ, wherein: X is a configured value or ratio, and Mₜₒₜₐₗ is a total number of initialized candidate multi-slot resources in the part of the one or more RB sets or total number of initialized candidate single-slot resources in the part of the one or more RB sets.

Preferably in certain embodiments, the first device determines whether to identify candidate resource comprising sub-channels in more than one RB set based on at least whether a first number of sub-channels for sidelink data transmission is larger than (or equal to) a threshold. The first device selects a number of sidelink resources from a set of identified candidate resources. The first device performs the one or more PSSCH or PSCCH transmissions on at least one of the selected number of sidelink resources.

Preferably in certain embodiments, when the first number of sub-channels for sidelink data transmission is larger than (or equal to) the threshold, the first device identifies the candidate resource comprising sub-channels in more than one RB set, and/or when the first number of sub-channels for sidelink data transmission is not larger than (e.g., smaller than or equal to) the threshold, the first device identifies the candidate resource comprising sub-channels in one RB set.

Preferably in certain embodiments, the threshold corresponds to a number of sub-channels in one RB set.

Preferably in certain embodiments, the first number of sub-channels for sidelink data transmission is determined based on at least a maximum number of sub-channels for PSSCH, a minimum number of sub-channels for PSSCH, and/or a CBR.

Preferably in certain embodiments, the first number of sub-channels for sidelink data transmission is a multiple integer number of at least one of two, three, or a further (or larger, greater, etc.) number of the (identified) more than one RB sets in the sidelink resource pool.

Preferably in certain embodiments, when the first number of sub-channels for sidelink data transmission is larger than (or equal to) the threshold, the first device is not allowed to determine the first number of sub-channels such that the first number of sub-channels is not divisible by any of two, three, or a further number of the (identified) more than one RB sets in the sidelink resource pool (e.g., may not be divisible by the number of the more than one RB sets).

Referring back to FIGS. 3 and 4, in one or more embodiments from the perspective of a first device, the device 300 includes a program code 312 stored in memory 310 of the transmitter. The CPU 308 could execute program code 312 to: (i) trigger or request sensing-based resource selection or re-selection for performing one or more PSSCH or PSCCH transmissions in a sidelink resource pool in unlicensed or shared spectrum; (ii) determine a first parameter for determining or initializing candidate multi-slot resources, wherein one candidate multi-slot resource comprises a set of single-slot resources with same frequency resources; (iii) receive a SCI for reserving one or more sidelink resources, wherein the first device excludes some candidate resources based on the reserved one or more sidelink resources; (iv) select a number of sidelink resources from valid/identified/remaining candidate multi-slot resources after exclusion; and (v) perform the one or more PSSCH or PSCCH transmissions on at least one of the selected number of sidelink resources. Moreover, the CPU 308 can execute the program code 312 to perform all of the described actions, steps, and methods described above, below, or otherwise herein.

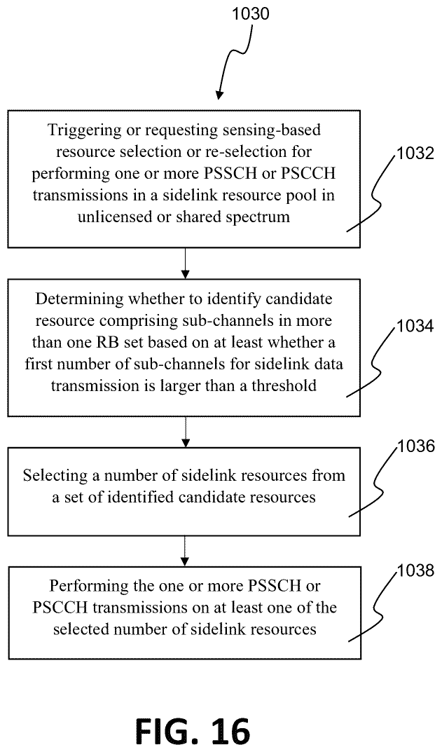

Referring to FIG. 16, with this and other concepts, systems, and methods of the present invention, a method 1030 for a first device comprises triggering or requesting sensing-based resource selection or re-selection for performing one or more PSSCH or PSCCH transmissions in a sidelink resource pool in unlicensed or shared spectrum (step 1032), determining whether to identify candidate resource comprising sub-channels in more than one RB set based on at least whether a first number of sub-channels for sidelink data transmission is larger than a threshold (step 1034), selecting a number of sidelink resources from a set of identified candidate resources (step 1036), and performing the one or more PSSCH or PSCCH transmissions on at least one of the selected number of sidelink resources (step 1038).

Preferably in certain embodiments, when the first number of sub-channels for sidelink data transmission is larger than the threshold, the first device identifies the candidate resource comprising sub-channels in more than one RB set, and/or when the first number of sub-channels for sidelink data transmission is not larger than the threshold, the first device identifies the candidate resource comprising sub-channels in one RB set.

Preferably in certain embodiments, the threshold corresponds to a number of sub-channels in one RB set.

Preferably in certain embodiments, when identifying a candidate resource comprising sub-channels in more than one RB set, the sub-channels in the more than one RB set are associated with a same set of sub-channel indexes.

Preferably in certain embodiments, the sidelink resource pool comprises more than one RB set, and/or the triggered or requested sensing-based resource selection or re-selection is performed on part of the more than one RB sets in the sidelink resource pool, and/or the first device checks or ensures that a number of valid/identified/remaining candidate resources is larger than or equal to X·Mₜₒₜₐₗ, wherein: X is a configured value or ratio, and Mₜₒₜₐₗ is a total number of initialized candidate resources in the part of the more than one RB sets.

Preferably in certain embodiments, the first number of sub-channels for sidelink data transmission is determined based on at least a maximum number of sub-channels for PSSCH, a minimum number of sub-channels for PSSCH, and/or a CBR.

Preferably in certain embodiments, the first number of sub-channels for sidelink data transmission is a multiple integer number of at least one of two, three, . . . a number of the more than one RB sets in the sidelink resource pool.

Preferably in certain embodiments, when the first number of sub-channels for sidelink data transmission is larger than the threshold, the first device is not allowed to determine the first number of sub-channels such that the first number of sub-channels is not divisible by any of two, three, . . . a further number of the more than one RB sets in the sidelink resource pool.

Referring back to FIGS. 3 and 4, in one or more embodiments from the perspective of a first device, the device 300 includes a program code 312 stored in memory 310 of the transmitter. The CPU 308 could execute program code 312 to: (i) trigger or request sensing-based resource selection or re-selection for performing one or more PSSCH or PSCCH transmissions in a sidelink resource pool in unlicensed or shared spectrum; (ii) determine whether to identify candidate resource comprising sub-channels in more than one RB set based on at least whether a first number of sub-channels for sidelink data transmission is larger than a threshold; (iii) select a number of sidelink resources from a set of identified candidate resources; and (iv) perform the one or more PSSCH or PSCCH transmissions on at least one of the selected number of sidelink resources. Moreover, the CPU 308 can execute the program code 312 to perform all of the described actions, steps, and methods described above, below, or otherwise herein.

Throughout the disclosure herein, multi-consecutive time transmission can comprise multi-consecutive TTI transmission, multi-consecutive subframe transmission, multi-consecutive slot transmission, multi-consecutive sub-slot transmission, or multi-consecutive symbol transmission.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a first device, comprising:
triggering or requesting sensing-based resource selection or re-selection for performing one or more Physical Sidelink Shared Channel (PSSCH) or Physical Sidelink Control Channel (PSCCH) transmissions in a sidelink resource pool in unlicensed or shared spectrum;
determining a first parameter for determining or initializing candidate multi-slot resources, wherein one candidate multi-slot resource comprises a set of single-slot resources with same frequency resources;
receiving a Sidelink Control Information (SCI) for reserving one or more sidelink resources, wherein the first device excludes some candidate resources based on the reserved one or more sidelink resources;
selecting a number of sidelink resources from valid, identified, or remaining candidate multi-slot resources after exclusion; and
performing the one or more PSSCH or PSCCH transmissions on at least one of the selected number of sidelink resources.

2. The method of claim 1, wherein the set of single-slot resources for the one candidate multi-slot resource are with a same starting sub-channel, a same number of sub-channels, a same starting Resource Block (RB) set, and a same number of RB sets.

3. The method of claim 1, wherein:
the first parameter is configured in a configuration of the sidelink resource pool; or
the first parameter is determined or derived based on a priority and/or a remaining Packet Delay Budget (PDB) associated with sidelink data of the one or more PSSCH or PSCCH transmissions; or
the first parameter is determined or derived based on a Channel Access Priority Class (CAPC) associated with sidelink data of the one or more PSSCH or PSCCH transmissions; or
the first parameter is determined or derived based on a Channel Occupancy Time (COT) duration; or
the first parameter is determined or derived based on a Channel Busy Rate (CBR) of the sidelink resource pool.

4. The method of claim 1, wherein the first device excluding the some candidate resources based on the reserved one or more sidelink resources comprises the first device excluding any candidate multi-slot resources which at least partially overlaps with the reserved one or more sidelink resources.

5. The method of claim 1, wherein:
the first device determines or initializes candidate single-slot resources; and/or
the first device excludes any candidate single-slot resources which at least partially overlaps with the reserved one or more sidelink resources; and/or
the first device determines or derives valid, identified, or remaining candidate single-slot resources after performing the exclusion; and/or
the first device determines or initializes the candidate multi-slot resources, based on the first parameter, from the valid, identified, or remaining candidate single-slot resources.

6. The method of claim 1, wherein:
when the first parameter is larger than one, the first devices determines or initializes the candidate multi-slot resources for performing the triggered or requested sensing-based resource selection or re-selection; and/or
when the first parameter is one, the first devices determines or initializes candidate single-slot resources for performing the triggered or requested sensing-based resource selection or re-selection.

7. The method of claim 1, wherein the valid, identified, or remaining candidate multi-slot resources are in a same one or more RB sets in the sidelink resource pool.

8. The method of claim 1, wherein:
the sidelink resource pool comprises one or more RB sets; and/or
the triggered or requested sensing-based resource selection or re-selection are performed on part of the one or more of RB sets in the sidelink resource pool; and/or
the first device checks or ensures that the number of the valid, identified, or remaining candidate multi-slot resources is larger than or equal to X·Mₜₒₜₐₗ, wherein:
X is a configured value or ratio, and
Mₜₒₜₐₗ is a total number of initialized candidate multi-slot resources in the part of the one or more RB sets or total number of initialized candidate single-slot resources in the part of the one or more RB sets.

9. A method of a first device, comprising:
triggering or requesting sensing-based resource selection or re-selection for performing one or more Physical Sidelink Shared Channel (PSSCH) or Physical Sidelink Control Channel (PSCCH) transmissions in a sidelink resource pool in unlicensed or shared spectrum;
determining whether to identify candidate resource comprising sub-channels in more than one Resource Block (RB) set based on at least whether a first number of sub-channels for sidelink data transmission is larger than a threshold;
selecting a number of sidelink resources from a set of identified candidate resources; and
performing the one or more PSSCH or PSCCH transmissions on at least one of the selected number of sidelink resources.

10. The method of claim 9, wherein:
when the first number of sub-channels for sidelink data transmission is larger than the threshold, the first device identifies the candidate resource comprising sub-channels in more than one RB set; and/or
when the first number of sub-channels for sidelink data transmission is not larger than the threshold, the first device identifies the candidate resource comprising sub-channels in one RB set.

11. The method of claim 9, wherein the threshold corresponds to a number of sub-channels in one RB set.

12. The method of claim 9, wherein when identifying a candidate resource comprising sub-channels in more than one RB set, the sub-channels in the more than one RB set are associated with a same set of sub-channel indexes.

13. The method of claim 9, wherein:
the sidelink resource pool comprises more than one RB set; and/or
the triggered or requested sensing-based resource selection or re-selection is performed on part of the more than one RB sets in the sidelink resource pool; and/or
the first device checks or ensures that a number of valid, identified, or remaining candidate resources is larger than or equal to X·Mₜₒₜₐₗ, wherein:
X is a configured value or ratio, and
Mₜₒₜₐₗ is a total number of initialized candidate resources in the part of the more than one RB sets.

14. The method of claim 9, wherein the first number of sub-channels for sidelink data transmission is determined based on at least a maximum number of sub-channels for PSSCH, a minimum number of sub-channels for PSSCH, and/or a Channel Busy Rate (CBR).

15. The method of claim 9, wherein the first number of sub-channels for sidelink data transmission is a multiple integer number of at least one of two, three, or a further number of the more than one RB sets in the sidelink resource pool.

16. The method of claim 9, wherein when the first number of sub-channels for sidelink data transmission is larger than the threshold, the first device is not allowed to determine the first number of sub-channels such that the first number of sub-channels is not divisible by any of two, three, or a further number of the more than one RB sets in the sidelink resource pool.

17. A first device, comprising:
a memory; and
a processor operatively coupled to the memory, wherein the processor is configured to execute a program code to:
trigger or request sensing-based resource selection or re-selection for performing one or more Physical Sidelink Shared Channel (PSSCH) or Physical Sidelink Control Channel (PSCCH) transmissions in a sidelink resource pool in unlicensed or shared spectrum;
determine a first parameter for determining or initializing candidate multi-slot resources, wherein one candidate multi-slot resource comprises a set of single-slot resources with same frequency resources;
receive a Sidelink Control Information (SCI) for reserving one or more sidelink resources, wherein the first device excludes some candidate resources based on the reserved one or more sidelink resources;
select a number of sidelink resources from valid, identified, or remaining candidate multi-slot resources after exclusion; and
perform the one or more PSSCH or PSCCH transmissions on at least one of the selected number of sidelink resources.

18. The first device of claim 17, wherein the set of single-slot resources for the one candidate multi-slot resource are with a same starting sub-channel, a same number of sub-channels, a same starting Resource Block (RB) set, and a same number of RB sets.

19. The first device of claim 17, wherein:
the first parameter is configured in a configuration of the sidelink resource pool; or
the first parameter is determined or derived based on a priority and/or a remaining Packet Delay Budget (PDB) associated with sidelink data of the one or more PSSCH or PSCCH transmissions; or
the first parameter is determined or derived based on a Channel Access Priority Class (CAPC) associated with sidelink data of the one or more PSSCH or PSCCH transmissions; or
the first parameter is determined or derived based on a Channel Occupancy Time (COT) duration; or
the first parameter is determined or derived based on a Channel Busy Rate (CBR) of the sidelink resource pool.

20. The first device of claim 17, wherein:
the first device excluding the some candidate resources based on the reserved one or more sidelink resources comprises the first device excluding any candidate multi-slot resources which at least partially overlaps with the reserved one or more sidelink resources; and/or
the first device determines or initializes candidate single-slot resources; and/or
the first device excludes any candidate single-slot resources which at least partially overlaps with the reserved one or more sidelink resources; and/or
the first device determines or derives valid, identified, or remaining candidate single-slot resources after performing the exclusion; and/or
the first device determines or initializes the candidate multi-slot resources, based on the first parameter, from the valid, identified, or remaining candidate single-slot resources.
